(19) United States
(12) Patent Application Publication
(10) Pub. No.: US 2017/0235681 A1
(43) Pub. Date: Aug. 17, 2017

(54) MEMORY SYSTEM AND CONTROL METHOD OF THE SAME

(71) Applicant: Kabushiki Kaisha Toshiba, Minato-ku (JP)

(72) Inventors: Satoshi KABURAKI, Tokyo (JP); KONOSUKE WATANABE, KAWASAKI (JP)

(73) Assignee: Kabushiki Kaisha Toshiba, Minato-ku (JP)

(21) Appl. No.: 15/219,705

(22) Filed: Jul. 26, 2016

Related U.S. Application Data
(60) Provisional application No. 62/294,334, filed on Feb. 12, 2016.

(51) Int. Cl. G06F 12/122; G06F 12/0864; G06F 12/10

(52) U.S. Cl. CPC G06F 12/122; G06F 12/10; G06F 12/0864; G06F 2212/1016; G06F 2212/1041; G06F 2212/69; G06F 2212/657

(57) ABSTRACT

According to one embodiment, a memory system includes a nonvolatile memory and a controller. The nonvolatile memory stores a multilevel address translation table including at least hierarchical first and second tables. The controller translates a logical address into a physical address by accessing a cache configured to cache both the first and second tables. The access range covered by each data portion of the second table is wider than the access range covered by each data portion of the first table. The controller preferentially evicts, from the cache, one of the cache lines which store the respective data portions of the first table.

### CROSS-REFERENCE TO RELATED APPLICATIONS

This application claims the benefit of U.S. Provisional Application No. 62/294,334, filed Feb. 12, 2016, the entire contents of which are incorporated herein by reference.

### FIELD

Embodiments described herein relate generally to a memory system.

### BACKGROUND

In recent years, storage devices including nonvolatile memories have widely been used as the main storage of various information processing apparatuses.

In such storage devices, address translation for translating logical addresses into physical addresses of a nonvolatile memory is performed using an address translation table.

In order to enhance the performance of the storage devices, there is a demand for efficiently executing address translation for translating logical addresses into physical addresses.

### BRIEF DESCRIPTION OF THE DRAWINGS

FIG. 1 is a block diagram illustrating a configuration of an information processing system including a memory system according to an embodiment.

FIG. 2 is a block diagram illustrating a configuration example of a nonvolatile memory in the memory system according to the embodiment.

FIG. 3 is a view for describing a cache (L2P table cache) for a multilevel L2P table (multilevel logical-to-physical address translation table) managed by the memory system of the embodiment.

FIG. 4 is a view illustrating a structure example of the L2P table cache.

FIG. 5 is a view illustrating a configuration example of a plurality of hierarchic tables included in the multilevel L2P table.

FIG. 6 is a view illustrating another configuration example of the hierarchic tables included in the multilevel L2P table.

FIG. 7 is a flowchart for describing data read processing including address translation processing, executed by the memory system of the embodiment.

FIG. 8 is a view for describing an example of an access range (capacity) covered by one data portion (one cache line) included in each table of the multilevel L2P table.

FIG. 9 is an exemplary view for describing in what ratio the data portions of the plurality of tables are held in the cache (L2P table cache), after a plurality of read accesses distributed in a certain access range are executed.

FIG. 10 is an exemplary view for describing in what ratio the data portions of the plurality of tables are held in the cache (L2P table cache), after a plurality of read accesses distributed in a certain wide access range are executed.

FIG. 11 is a view for describing first timestamp control processing executed by the memory system of the embodiment.

FIG. 12 is a view for describing second timestamp control processing executed by the memory system of the embodiment.

FIG. 13 is a view for describing third timestamp control processing executed by the memory system of the embodiment.

FIG. 14 is a view for describing fourth timestamp control processing executed by the memory system of the embodiment.

FIG. 15 is a view for describing a sequence of cache control processing executed by the memory system of the embodiment at a cache hit of a level-1 address translation table (L1 L2P table).

FIG. 16 is a view for describing a sequence of cache control processing executed by the memory system of the embodiment at a cache miss of the L1 L2P table and at a cache hit of a level-2 address translation table (L2 L2P table).

FIG. 17 is a view for describing a part of a sequence of cache control processing executed by the memory system of the embodiment at a cache miss of the L1 L2P table, at a cache miss of the L2 L2P table, and at a cache hit of a level-3 address translation table (L3 L2P table).

FIG. 18 is a view for describing the remaining part of the sequence of cache control processing executed by the memory system of the embodiment at a cache miss of the L1 L2P table, at a cache miss of the L2 L2P table, and at a cache hit of the L3 L2P table.

FIG. 19 is a flowchart illustrating a procedure of timestamp update processing and replacement target cache line select processing executed by the memory system of the embodiment.

FIG. 20 is a flowchart illustrating another procedure of the timestamp update processing and replacement target cache line select processing executed by the memory system of the embodiment.

FIG. 21 is a flowchart illustrating yet another procedure of the timestamp update processing and replacement target cache line select processing executed by the memory system of the embodiment.

FIG. 22 is a flowchart illustrating a further procedure of the timestamp update processing and replacement target cache line select processing executed by the memory system of the embodiment.

FIG. 23 is a flowchart illustrating a part of the procedure of a read operation executed by the memory system of the embodiment.

FIG. 24 is a flowchart illustrating another part of the procedure of the read operation executed by the memory system of the embodiment.

FIG. 25 is a flowchart illustrating the remaining part of the procedure of the read operation executed by the memory system of the embodiment.

### DETAILED DESCRIPTION

Embodiments will be described with reference to the accompanying drawings.

In general, in accordance with one embodiment, a memory system includes a nonvolatile memory, and a controller electrically connected to the nonvolatile memory. The nonvolatile memory stores a multilevel address translation table used for translating a logical address into a physical address in the nonvolatile memory. The multilevel address translation table comprises at least hierarchical first and second tables. The first table includes a plurality of data portions. The second table includes a plurality of data portions. Access ranges covered by the respective data portions of the second table are wider than access ranges covered by the respective data portions of the first table.

The controller translates the logical address into a physical address by accessing a cache configured to cache both the first and second tables. The cache includes a plurality of cache lines. Each of the cache lines stores one of the data portions included in the first table or one of the data portions included in the second table.

When replacement of one of the cache lines is to be performed because of a cache miss in the cache, the controller evicts, from the cache, one of the cache lines which store the data portions of the first table in preference to the cache lines which store the data portions of the second table.

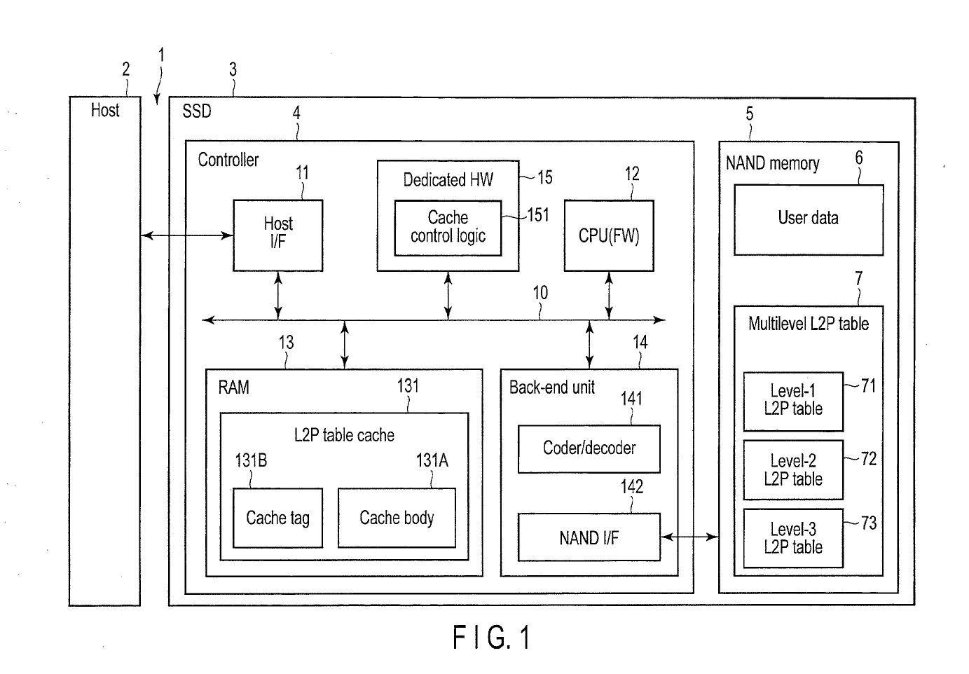

Referring first to FIG. 1, a configuration of an information processing system 1 including a memory system according to an embodiment will be described.

This memory system can function as a storage device configured to write data to a nonvolatile memory, and to read data from the nonvolatile memory. The memory system is realized as, for example, a NAND flash technology-based storage device 3. The storage device 3 may be realized as a solid state drive (SSD), or an embedded memory device, such as a universal flash storage (UFS) device. Below, the storage device 3 is assumed to be realized as a solid state drive (SSD), although it is not limited to it.

The information processing system 1 comprises a host (host device) 2 and the storage device (SSD) 3. The host 2 may be an information processing apparatus, such as a personal computer or a server computer. The SSD 3 may be used as an external storage device for the information processing apparatus functioning as the host 2. The SSD 3 may be built in the information processing apparatus, or may be connected to the information processing apparatus through a cable or a network.

The host 2 and the SSD 3 are connected to each other by a communication interface. As the standard of the communication interface, PCIe (PCI Express), SATA (Serial Advanced Technology Attachment), SAS (Serial Attached SCSI), an interface for UFS (Universal Flash Storage) protocol (for example, MIPI (Mobile Industry Processor Interface), UniPro), etc., may be used.

The SSD 3 comprises a controller 4 and a nonvolatile memory (NAND memory) 5. The NAND memory 5 may include a plurality of NAND flash memory chips.

The NAND memory 5 stores user data 6 and a multilevel logical-to-physical address translation table (multilevel L2P table) V.

The multilevel L2P table 7 is used to translate logical addresses into respective physical addresses of the NAND memory 5. The multilevel L2P table 7 includes a plurality of hierarchical tables. The plurality of tables (also called various types of tables) are used for multistage logical-to-physical address translation. The number of tables included in the multilevel L2P table 7 corresponds to the number of stages for logical-to-physical address translation. Although the number of the tables included in the multilevel L2P table 7 is not limited, the number of the tables may be two (that is, the number of stages for address translation is two), or three (that is, the number of stages for address translation is three), or four or more (that is, the number of stages for address translation is four or more).

For example, the multilevel L2P table 7 may be a 3-level address translation table for translating a logical address into a physical address using address translation of three stages. In this case, the multilevel L2P table 7 may include three hierarchical tables used by the respective three-stage address translations, that is, may include a level-1 L2P table (L1 L2P table) 71, a level-2 L2P table (L2 L2P table) 72, and a level-3 L2P table (L3 L2P table) 73.

Using the multilevel L2P table 7, the controller 4 may manage correspondence between logical addresses and physical addresses in units of a particular management size (called “page”). Although not limited, the particular management size (page size) may be typically 4096 bytes (4 KiB), for example.

As the logical address, a logical block address (LBA) is usually used. The physical address indicates a location (physical storage location) in the NAND memory 5, where user data is stored. The physical address may be expressed by, for example, a combination of a physical block number and a physical page number. In the embodiment, data written to the NAND memory 5 in accordance with a write request (write command) received from the host 2 will be referred to as user data.

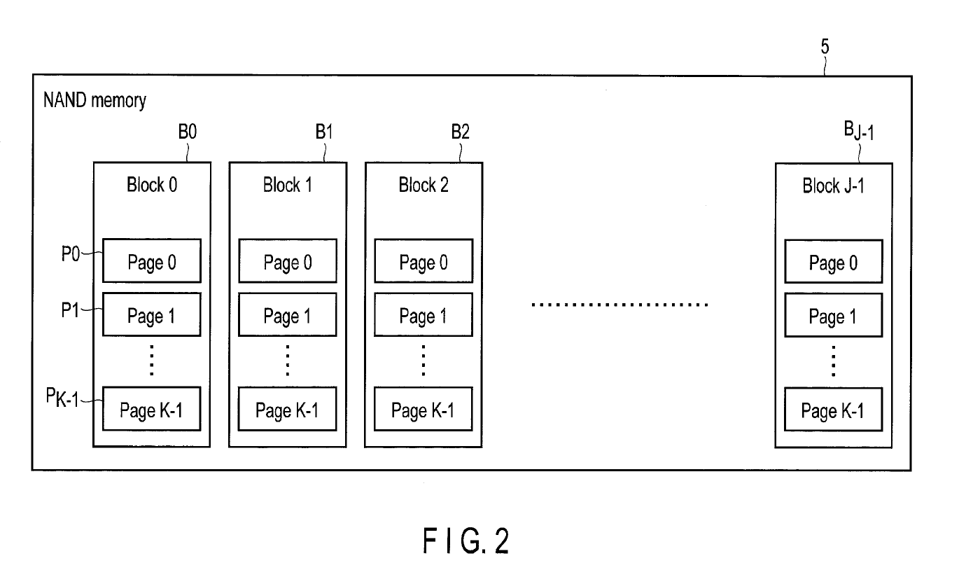

The NAND memory 5 includes one or more memory chips that each has a memory cell array. The memory cell array includes a plurality of memory cells that are arranged in a matrix. As illustrated in FIG. 2, the memory cell array of the NAND memory 5 includes many NAND blocks (physical blocks) B0 to Bj−1. Physical blocks B0 to Bj−1 each function as an erase unit. In some cases, the physical block is also called “block” or “erase block.”

Physical blocks B0 to Bj−1 each include many pages (physical pages). That is, physical blocks B0 to Bj−1 each include pages P0, P1, . . . , Pk−1. In the NAND memory 5, data reading and data writing are performed in units of a page.

The controller 4 controls the NAND memory 5 as a nonvolatile memory. The controller 4 may function as a flash translation layer (FTL) configured to execute data management and block management of the NAND memory 5.

The data management includes, for example, (1) management of mapping information indicative of the correspondence between logical addresses (logical block addresses: LBAs) and physical addresses, and (2) processing for hiding a page-unit read/write operation and a block-unit erase operation. The mapping between LBAs and physical addresses is managed using the multilevel L2P table 7. A physical address corresponding to a certain LBA indicates a storage location in the NAND memory 5, where the data of this LBA was written.

A data write to the page is possible only once per one erase cycle. Thus, the controller 4 maps write (overwrite) to the same LBA to another page in the NAND memory 5. That is, the controller 4 writes data (write data), designated by a write command received from the host 2, to a subsequent available page, regardless of the LBA of this data. Then, the controller 4 updates the L2P table 7 to associate this LBA with a physical address corresponding to the page to which the data has actually been written.

The block management includes a bad block management, wear leveling, garbage collection, etc.

The host 2 sends a read command and a write command to the SSD 3. The read command is a command that requests the SSD 3 to execute a data read. The read command includes the LBA (starting LBA) of data to be read, and the transfer length of this data. The write command is a command that requests the SSD 3 to execute a data write. The write command includes the LBA (starting LBA) of write data (namely, data to be written), and the transfer length of this write data.

The controller 4 can store a part of the multilevel L2P table 7 as a L2P table cache 131 in a random access memory (RAM) 13 that is a volatile memory included in the controller 4. The L2P table cache 131 functions as a cache configured not to cache a particular one table included in the multilevel L2P table 7, but to cache all types of tables (the L1 L2P table 71, the L2 L2P table 72 and the L3 L2P table 73) included in the multilevel L2P table 7. In other words, the L2P table cache 131 is a shared cache (also called a unified cache) for the various types of tables.

The controller 4 can translate a logical address, received from the host 2, into a physical address by accessing the L2P table cache 131.

For example, when having received a read command from the host 2, the controller 4 searches the L2P table cache 131 for a data portion (address translation information) required to translate a logical address (LBA), designated by the read command, into a physical address. If this data portion is present in the L2P table cache 131 (cache hit), the controller 4 can immediately read the data portion from the L2P table cache 131. Therefore, the logical-to-physical address translation using the L2P table cache 131 can reduce the number of times by which the multilevel L2P table 7 in the NAND memory 5 should be accessed, thereby improving the performance of the SSD 3.

Next, the configuration of the controller 4 will be described.

The controller 4 is electrically connected to the NAND memory 5, and is configured to control the NAND memory 5. This controller 4 comprises a host interface 11, a CPU 12, a RAM 13, a back-end unit 14, a dedicated hardware (HW) 15, etc. The host interface 11, CPU 12, RAM 13, back-end unit 14 and dedicated hardware (HW) 15 are interconnected via a bus 10.

The host interface 11 receives various commands, such as a write command and a read command, from the host 2. The host interface 11 transmits responses to the commands to the host 2.

The CPU 12 is a processor configured to control the operation of the SSD 3. When the SSD 3 is supplied with power, the CPU 12 executes particular processing by loading, onto the RAM 13, a predetermined control program (firmware FW) which is stored in a ROM (not shown) or the NAND memory 5. The CPU 12 executes, for example, command processing for processing various commands from the host 2, in addition to the above-mentioned FTL processing. The operation of the CPU 12 is controlled by the firmware FW that is executed by the CPU 12. A part or all of the command processing may be executed by the dedicated hardware 15.

The RAM 13 is a volatile memory built in the controller 4. Although the type of the RAM 13 is not limited, it may be, for example, a static RAM (SRAM). The storage area of the RAM 13 is used as the work area of the CPU 12. Predetermined control programs and various types of system management information, loaded from the NAND memory 5, are stored in the RAM 13.

Further, the storage area of the RAM 13 is also used as the above-mentioned L2P table cache 131. In other words, the L2P table cache 131 is implemented in the RAM 13 in the controller 4.

The L2P table cache 131 includes a cache body 131A for caching various types of tables in the multilevel L2P table 7, and a cache tag 131B for managing the cache body 131A. The cache tag 131B may be formed integral with the cache body 131A, or may be separate from the cache body 131A.

The cache body 131A includes a plurality of cache lines. The cache tag 131B includes a plurality of entries (also called tag entries) corresponding to the cache lines. Each entry of the cache tag 131B can hold various types of information for managing each data portion stored in the corresponding cache line.

The back-end unit 14 includes a coder/decoder 141 and a NAND interface 142. The coder/decoder 141 may function as, for example, an error correction code (ECC) encoder and an ECC decoder.

The coder/decoder 141 may also function as a randomizer (or scrambler). In this case, at the time of a data write, the encoder/decoder 141 may detect a specific bit pattern, in which either “1” or “0” continues for at least a predetermined bit length, from the bit pattern of write data, and may change the detected specific bit pattern to another bit pattern in which “1” or “0” scarcely continues.

The NAND interface 142 functions as a NAND controller configured to control the NAND memory 5.

The dedicated hardware 15 may include a circuit for controlling the L2P table cache 131. The circuit for controlling the L2P table cache 131 may include, for example, a circuit configured to determine the cache hit/miss of the L2P table cache 131, a circuit configured to select a replacement target cache line to be evicted from the L2P table cache 131, etc.

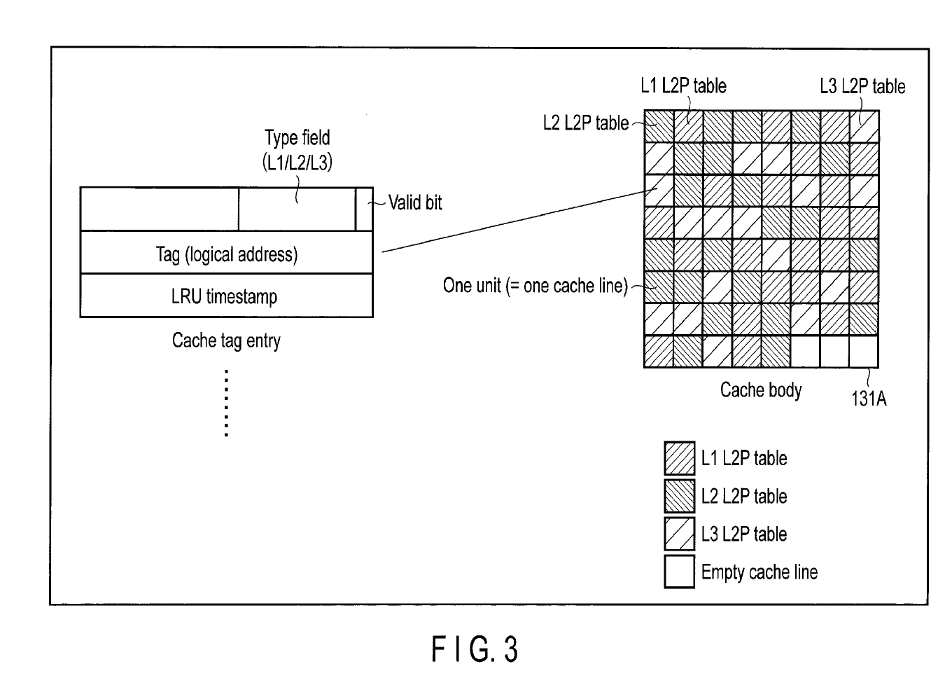

FIG. 3 schematically shows the L2P table cache 131.

In the cache body 131A, a part of the L1 L2P table 71, a part of the L2 L2P table 72, and a part of the L3 L2P tables 73 are cashed in an intermingled way. In other words, each cache line of the cache body 131A is used to store one of a plurality of data portions in the L1 L2P table 71, one of a plurality of data portions in the L2 L2P table 72, or one of a plurality of data portions in the L3 L2P table 73. Each of the data portions is data corresponding to one unit having the same size as one cache line.

The L2P table cache 131 may be a fully associative cache or a set associative cache. A description will now be given mainly of a case where the L2P table cache 131 is realized as the fully associative cache that can store, in an arbitrary cache line of the L2P table cache 131, an arbitrary data portion in an arbitrary table included in the multilevel L2P table 7, although the L2P table cache 131 is not limited to it.

Moreover, as a replacement policy for selecting (determining) a cache line to be evicted, a least recently used (LRU) policy for evicting a cache line that has not been used for the longest time may be used.

One tag entry corresponding to one cache line may store a type field, a valid bit, a tag (tag address), and an LRU timestamp (also called a timestamp or an LRU count).

A value stored in the type field indicates the data portion of which type of table is stored in the corresponding cache line. For example, in the type field of a tag entry corresponding to a cache line that stores a certain data portion in the L1 L2P table 71, a value indicating the L1 L2P table 71 is stored.

The valid bit indicates whether the corresponding cache line is valid or not. The valid indicates that the corresponding cache line is in an active state, i.e., the data portion of a certain table is stored in the corresponding cache line.

The tag is used to identify a data portion of the multilevel L2P table 7 stored in the corresponding cache line.

The cache-hit/cache-miss determination may be performed using the type field, the valid bit (VB), and the tag.

The LRU timestamp represents the LRU information of a data portion stored in the corresponding cache line. The LRU timestamp is updated for each access of the data portion in the corresponding cache line. More specifically, the LRU timestamp is updated when the corresponding cache line is hit, and also when a new data portion is loaded to the corresponding cache line.

As a value of the LRU timestamp, an arbitrary value can be used, with which it can be determined whether the data portion stored in the corresponding cache line has recently been used (accessed) or has not been used (accessed) for a long time.

For instance, a counter value of a serial counter may be stored as the LRU timestamp in the corresponding tag entry. In this case, whenever the L2P table cache 131 is accessed for that search, that is, when a certain cache hit has occurred or a new data portion has been loaded to the L2P table cache 131, the current counter value of the serial counter may be incremented by, for example, +1. Further, the LRU timestamp corresponding to the cache line in which the cache hit has occurred, or the cache line to which the new data portion has been loaded, may be updated by the incremented current counter value (the latest counter value).

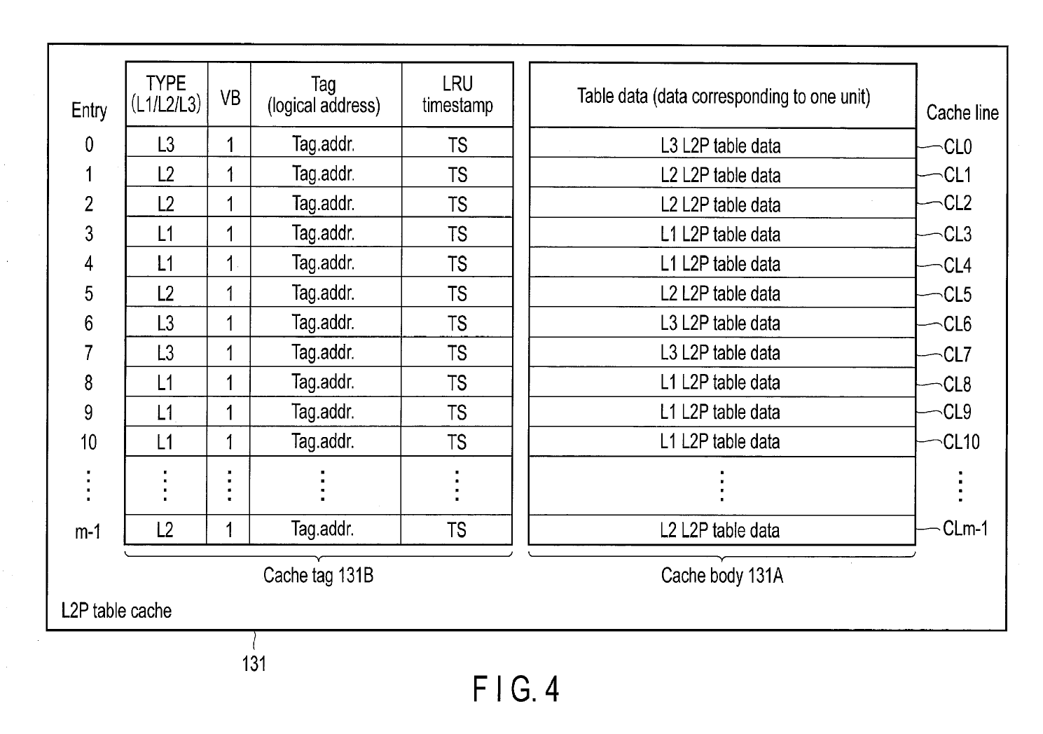

FIG. 4 shows a configuration example of the L2P table cache 131.

The cache body 131A includes a plurality of cache lines CL0 to CLm−1 that have respective fixed sizes.

The cache tag 131B includes m tag entries corresponding to cache lines CL0 to CLm−1. For example, when cache line CL0 stores one certain data portion in the L3 L2P table 73, the following data is stored in a tag entry of entry 0:

(1) Type field indicating the L3 L2P table

(2) Valid bit (VB) indicating validity (for example, “1”)

(3) Tag (tag address) indicating a data portion corresponding to which logical address is stored in cache line CL0

(4) LRU timestamp (TS) corresponding to the data portion stored in cache line CL0

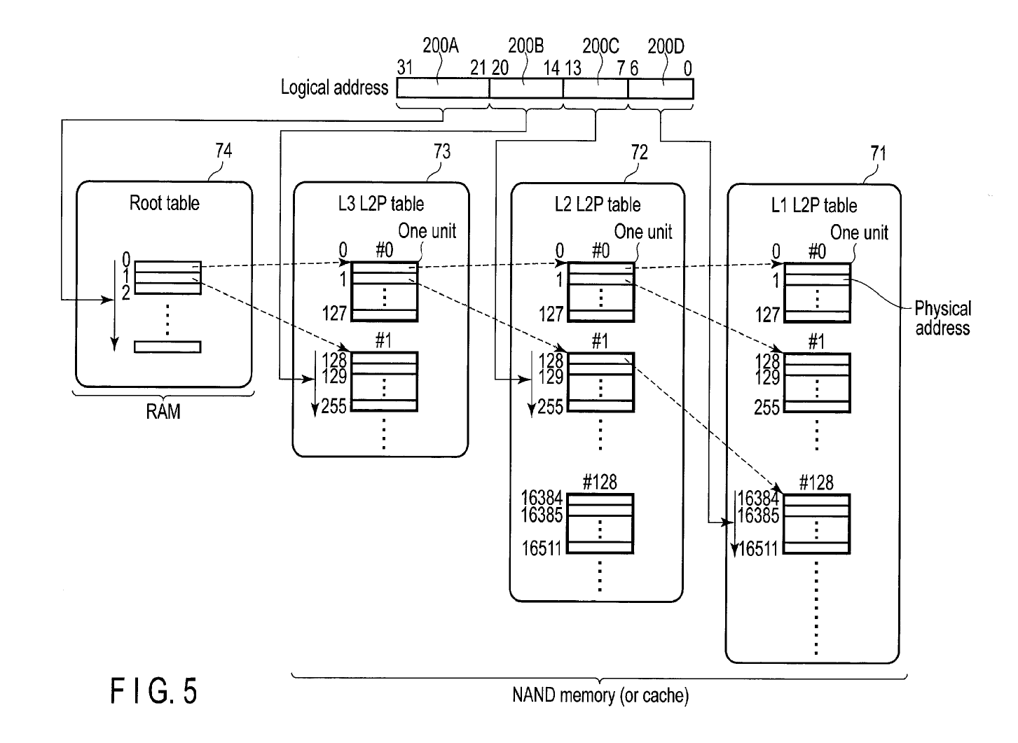

FIG. 5 shows configuration examples of a plurality of hierarchical tables included in the multilevel L2P table 7.

The L1 L2P table 71 may be an address translation table for storing physical addresses corresponding to respective logical addresses. The L1 L2P table 71 may include a plurality of data portions (data portion #0, data portion #1, . . . , data portion #128, . . . ). In other words, the L1 L2P table 71 may be divided into the plurality of data portions (data portion #0, data portion #1, . . . , data portion #128, . . . ). Each of these data portions is data (corresponding to one unit) which has a size corresponding to one cache line.

One data portion (data corresponding to one unit) of the L1 L2P table 71 may include a plurality of physical addresses. Each of the physical addresses indicates a location in the NAND memory 5, where user data is stored.

The number of the physical addresses included in one data portion of the L1 L2P table 71 is determined based on a bit width for expressing one physical address, and a size corresponding to one cache line (the size of data corresponding to one unit). One data portion may have an arbitrary size, if it can store the plurality of physical addresses. The size of data corresponding to one unit may be, for example, 256 bytes, 512 bytes, 1024 bytes (1 KiB), 2048 bytes (2 KiB), or 4096 bytes (4 KiB). However, the size is not limited to them.

For example, in a case where the bit width of one physical address is 32 bits (4 bytes) and the size of data corresponding to one unit is 512 bytes, each data portion can include 128 entries (namely, 128 physical addresses).

The locations in the NAND memory 5, where the data portions (data portion #0, data portion #1, . . . , data portion #128, . . . ) of the L1 L2P table 71 are stored, are managed by the L2 L2P table 72.

The L2 L2P table 72 may also include a plurality of data portions (data portion #0, data portion #1, . . . , data portion #128, . . . ) each having a size corresponding to one cache line (the size of data corresponding to one unit). In other words, the L2 L2P table 72 may be divided into the plurality of data portions (data portion #0, data portion #1, . . . , data portion #128, . . . ).

Each of the data portions of the L2 L2P table 72 may include a plurality of entries, for example, 128 entries. Each entry indicates a location in the NAND memory 5, where one certain data portion of the L1 L2P table 71 is stored.

The locations in the NAND memory 5, where the data portions (data portion #0, data portion #1, . . . , data portion #128, . . . ) of the L2 L2P table 72 are stored, are managed using the L3 L2P table 73.

The L3 L2P table 73 may also include a plurality of data portions (data portion #0, data portion #1, . . . ) each having a size corresponding to one cache line (the size of data corresponding to one unit). In other words, the L3 L2P table 73 may be divided into the plurality of data portions (data portion #0, data portion #1, . . . ).

Each of the data portions of the L3 L2P table 73 may include a plurality of entries, for example, 128 entries. Each entry indicates a location in the NAND memory 5, where one certain data portion of the L2 L2P table 72 is stored.

The locations in the NAND memory 5, where the data portions (data portion #0, data portion #1, . . . ) of the L3 L2P table 73 are stored, are managed using system management information called a root table 74. When the SSD 3 is supplied with power, the root table 74 may be loaded from the NAND memory to the RAM 13, and thereafter may be kept in the RAM 13.

The root table 74 may include a plurality of entries. Each entry indicates a location in the NAND memory 5, where one certain data portion of the L3 L2P table 73 is stored.

A logical address as a translation target is divided into four subfields, namely, subfield 200A, subfield 200B, subfield 200C and subfield 200D. If a logical sector designated by an LBA is the same size as the above-mentioned particular management size (page size), an LBA itself included in a read command received from the host 2 may be used as the translation target logical address. In contrast, if the size of a logical sector designated by an LBA differs from the above-mentioned predetermined management size (page size), the LBA may be translated into an address (also called a logical page address) corresponding to the above-mentioned particular management size, and the resultant logical page address may be used as the translation target logical address.

In the configuration example of the multilevel L2P table 7 shown in FIG. 5, the L1 L2P table 71 includes a maximum number of data portions. The L2 L2P table 72 includes a second maximum number of data portions. The L3 L2P table 73 includes a least number of data portions. Therefore, it is sufficient if the root table 74 includes a small number of entries, which is the same as the number of data portions of the L3 L2P table 73. Thus, the configuration of the above-mentioned three hierarchical tables enables the size of the storage area in the RAM 13, which is required for storing the root table 74, to be sufficiently reduced.

A description will now be given of the outline of logical-to-physical address translation processing performed using the multilevel L2P table 7 of FIG. 5.

For facilitating the description below, assume a case where each table is read from the NAND memory 5.

<Logical-to-Physical Address Translation in a First Stage>

First, the root table 74 is referred to, using subfield 200A in a translation target logical address, thereby acquiring the address (a location in the NAND memory 5) of a specific data portion in the L3 L2P table 73. Based on this address, the specific data portion in the L3 L2P table 73 is read from the NAND memory 5.

Further, using subfield 200B, the specific data portion in the L3 L2P table 73 is referred to, thereby selecting one entry from the specific data portion in the L3 L2P table 73. The selected entry holds the address (a location in the NAND memory 5) of one data portion in the L2 L2P table 72. Based on this address, the one data portion of the L2 L2P table 72 is read from the NAND memory 5.

<Logical-to-Physical Address Translation in a Subsequent Stage>

Subsequently, the one data portion of the L2 L2P table 72 is referred to, using subfield 200C in the translation target logical address, thereby selecting one entry from the one data portion in the L2 L2P table 72. The selected entry holds the address (a location in the NAND memory 5) of one data portion in the L1 L2P table 72. Based on this address, the one data portion of the L1 L2P table 72 is read from the NAND memory 5.

<Address Translation in a Last Stage>

Subsequently, the one data portion in the L1 L2P table 71 is referred to, using subfield 200D, thereby selecting one entry from the one data portion in the L2 L1P table 71. The selected entry holds a location in the NAND memory 5 where user data designated by a logical address in a read command is stored, namely, a physical address corresponding to the logical address in the read command. Based on the physical address, the user data is read from the NAND memory 5.

In the embodiment, a part of the multilevel L2P table 7 of FIG. 5 can be cached in the L2P table cache 131. In the multilevel L2P table 7 of FIG. 5, any data portion of any table can be identified by a logical address. That is, in the L2P table cache 131, for each data portion of each table in the multilevel L2P table 7, a part of the corresponding logical address can be used as a tag address for identifying each data portion.

For instance, for the respective data portions of the L1 L2P table 71, subfields 200A to 200C in the logical address may be used as tag addresses (tag addresses for L1). Similarly, for the respective data portions of the L2 L2P table 72, subfields 200A and 200B in the logical address may be used as tag addresses (tag addresses for L2). For the respective data portions of the L3 L2P table 73, subfield 200A in the logical address may be used as a tag address (tag address for L3).

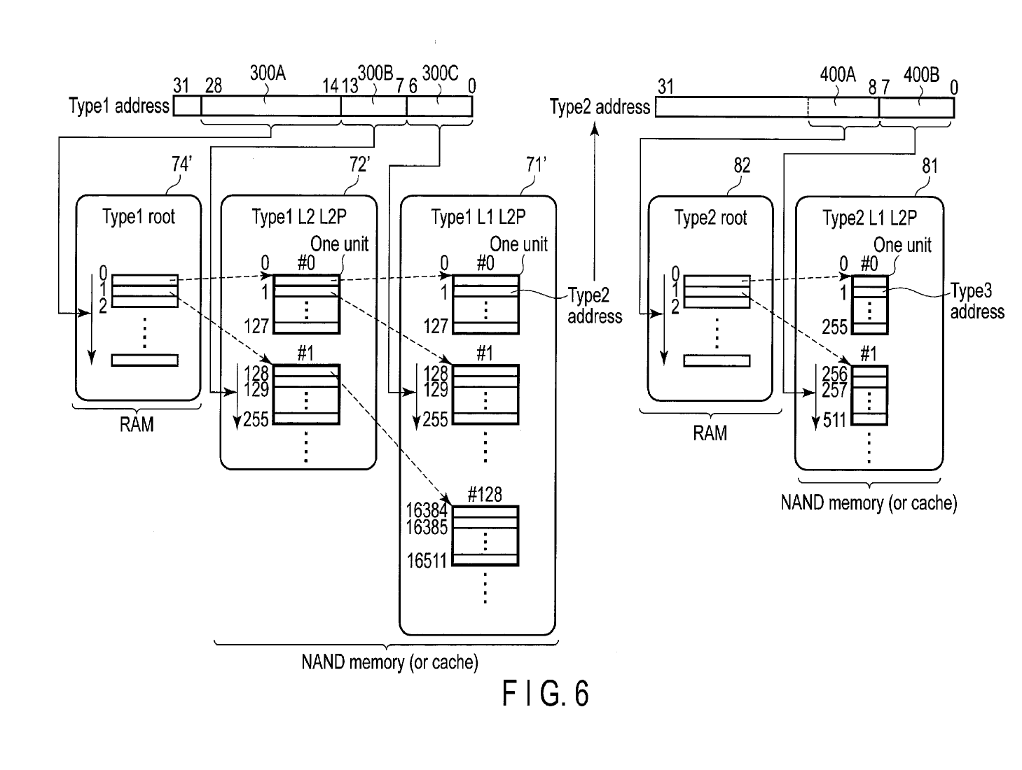

FIG. 6 shows another configuration example of the hierarchical tables included in the multilevel L2P table 7.

In the multilevel L2P table 7 of FIG. 6, first, a type-1 address is translated into a type-2 address, and the type-2 address is further translated into a physical address indicating an actual location in the NAND memory 5, where the user data is stored.

The address translation from the type-1 address to the type-2 address may be executed using a type-1 level 1 (L1) L2P table 71′ and a type-1 level 2 (L2) L2P table 72′.

The type-1 L1 L2P table 71′ may be an address translation table for storing type-2 addresses corresponding to type-1 addresses (logical addresses). The type-1 L1 L2P table 71′ may include a plurality of data portions (data portion #0, data portion #1, . . . data portion #128, . . . ). Each of these data portions is data corresponding to one unit, which has a size corresponding to one cache line.

Each data portion of the type-1 L1 L2P table 71′ may include a plurality of type-2 addresses. The number of the type-2 addresses included in one data portion of the type-1 L1 L2P table 71′ is determined by a bit width for expressing one type-2 address, and the size corresponding to one cache line (that is, a data size corresponding to one unit). For example, as in a case where the bit width of one type-2 address is 32 bits (4 bytes), and the size of data corresponding to one unit is 512 bytes, each data portion can include 128 entries (namely, 128 type-2 addresses).

The locations in the NAND memory 5, where the data portions (data portion #0, data portion #1, . . . , data portion #128, . . . ) of the type-1 L1 L2P table 71′ are stored, are managed using the type-1 L2 L2P table 72′.

The type-1 L2 L2P table 72′ may also include a plurality of data portions (data portion #0, data portion #1, . . . ) each having a size corresponding to one cache line. Each of the data portions of the type-1 L2 L2P table 72′ may include a plurality of (for example, 128) entries. Each entry indicates a location in the NAND memory 5, where a certain one data portion in the type-1 L1 L2P table 71′ is stored.

The locations in the NAND memory 5, where the data portions (data portion #0, data portion #1, . . . ) of the type-1 L2 L2P table 72′ are stored, are managed by system management information called a type-1 root table 74′. The type-1 root table 74′ may be loaded from the NAND memory 5 to the RAM 13, for example, when the SSD 3 is supplied with power, and may thereafter be kept in the RAM 13.

The type-1 root table 74′ may include a plurality (for example, 128) of entries. Each entry represents a location (address) in the NAND memory 5, where one data portion in the type-1 L2 L2P table 72′ is stored.

The translation target logical address is divided into three subfields, i.e., subfield 300A, subfield 300B and subfield 300C. An LBA itself included in a read command received from the host 2 may be used as the translation target logical address. Alternatively, this LBA may be translated into an address (internal logical address) corresponding to the above-mentioned particular management size, and the resultant internal logical address may be used as the translation target logical address.

The address translation from a type-2 address into a physical address is executed, using a type-2 level 1 (L1) L2P table 81. An example of the address translation from the type-2 address into the physical address may include a process for translating an index of a physical block number included in the type-2 address into an actual physical block number in the NAND memory 5, although it is not limited to it.

The type-2 L1 L2P table 81 may include a plurality of data portions (data portion #0, data portion #1, . . . ). Each of these data portions is data corresponding to one unit, which has a size corresponding to one cache line. Each data portion of the type-2 L1 L2P table 81 may include a plurality of actual physical block numbers in the NAND memory 5. The number of the physical block numbers included in one data portion of the type-2 L1 L2P table 81 is determined from a bit width for expressing one physical block number, and a size corresponding to one cache line (that is, a data size corresponding to one unit). For instance, as in a case where the bit width of one physical block number is 16 bits (2 bytes), and the size of data corresponding to one unit is 512 bytes, each data portion which has the data size corresponding to one unit can include 256 entries (namely, 256 physical block numbers).

The locations in the NAND memory 5, where the data portions (data portion #0, data portion #1, . . . ) of the type-2 L1 L2P table 81 are stored, are managed by system management information called a type-2 root table 82. The type-2 root table 82 may be loaded from the NAND memory 5 to the RAM 13, for example, when the SSD 3 is supplied with power, and may thereafter be retained in the RAM 13.

Subfield 400A in the type-2 address is used as an index for selecting a certain entry in the type-2 root table 82. Subfield 400B in the type-2 address is used to select one entry from a data portion in the type-2 L1 L2P table 81, designated by the type-2 root table 82.

In the embodiment, a part of the multilevel L2P table 7 of FIG. 6 can be cached in the L2P table cache 131. In the L2P table cache 131, for example, a part of a type-1 address (logical address) can be used as a tag address for each data portion of the type-1 L1 L2P table 71′ and the type-1 L2 L2P 72′, and a part of a type-2 address can be used as a tag address for each data portion of the type-2 L1 L2P table 81.

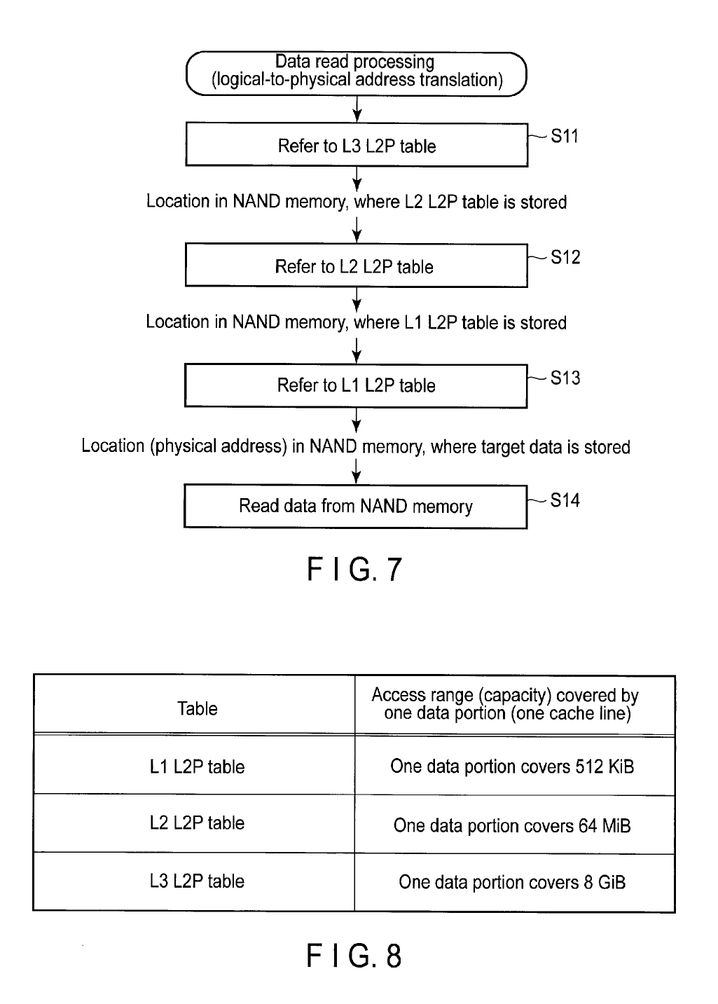

The flowchart of FIG. 7 shows a procedure example of data read processing that includes address translation processing performed using the multilevel L2P table 7 stored in the NAND memory 5.

Assume here that the multilevel L2P table 7 has a configuration as illustrated in FIG. 5.

In step S11, the controller 4, first, obtains a location in the NAND memory 5, where a desired data portion of the L3 L2P table 73 is stored, and reads the desired data portion of the L3 L2P table 73 from the NAND memory 5.

The desired data portion means address translation information required for logical-to-physical address translation of a logical address designated by a read command received from the host 2. Subsequently, the controller 4 selects one entry from the desired data portion of the L3 L2P table 73, using subfield 200B, thereby obtaining a location in the NAND memory 5, where a desired data portion of the L2 L2P table 72 is stored.

In step S12, the controller 4 reads the desired data portion of the L2 L2P table 72 from the NAND memory 5. Subsequently, the controller 4 selects one entry from the desired data portion of the L2 L2P table 72, using subfield 200C, and obtains a location in the NAND memory 5, where a desired data portion of the L1 L2P table 71 is stored.

In step S13, the controller 4 reads the desired data portion of the L1 L2P table 71 from the NAND memory 5. After that, the controller 4 selects one physical address from the desired data portion of the L1 L2P table 71 using subfield 200D, thereby obtaining a location in the NAND memory 5, where target user data corresponding to the logical address designated by the read command is stored.

In step S14, the controller 4 reads the target user data from the NAND memory 5, and returns the read user data to the host 2.

As described above, in general, it is necessary to perform several read accesses to the multilevel L2P table 7 in the NAND memory 5, in order to perform logical-to-physical address translation.

In the embodiment, since various types of tables in the multilevel L2P table 7 are cached in the L2P table cache 131, the number of accesses to the multilevel L2P table 7 required for logical-to-physical address translation can be reduced.

If the desired data portion of the L3 L2P table 73 exists in the L2P table cache 131, it can be immediately read from the L2P table cache 131. This can dispense with processing of reading the desired data portion of the L3 L2P table 73 from the NAND memory 5. As a result, logical-to-physical address translation can be performed at high speed.

If the desired data portion of the L2 L2P table 72 exists in the L2P table cache 131, it can be immediately read from the L2P table cache 131, which can also dispense with processing of reading the desired data portion of the L2 L2P table 72 from the NAND memory 5.

If the desired data portion of the L1 L2P table 71 exists in the L2P table cache 131, it can be immediately read from the L2P table cache 131, which can also dispense with processing of reading the desired data portion of the L1 L2P table 71 from the NAND memory 5.

FIG. 8 shows an access range (capacity) example covered by one data portion (one cache line) of each table included in the multilevel L2P table.

In the configuration example of the multilevel L2P table 7 shown in FIG. 5, the access range (capacity) covered by one data portion of the L3 L2P table 73 is greatest. The access range covered by one data portion means a capacity covered by one data portion. The access range (capacity) covered by one data portion of the L2 L2P table 72 is second greatest. The access range (capacity) covered by one data portion of the L1 L2P table 71 is smallest.

In the configuration example of the multilevel L2P table 7 shown in FIG. 5, each of the data portions of the L1 L2P table 71 may include 128 entries (128 physical addresses), as described above. The 128 physical addresses are physical addresses corresponding to respective continuous 128 logical addresses (continuous 128 logical page addresses). If the capacity (page size) covered by one physical address is, for example, 4 KiB, each data portion in the L1 L2P table 71 covers an access range (capacity) of 512 KiB (=4 KiB×128). In other words, it covers a storage space corresponding to continuous 128 logical addresses.

Each of the data portions of the L2 L2P table 72 may also include 128 entries. In this case, each data portion of the L2 L2P table 72 covers an access range (capacity) of 64 MiB (=512 KiB×128).

Each data portion of the L3 L2P table 73 may also include 128 entries. In this case, each data portion of the L3 L2P table 73 covers an access range (capacity) of 8 GiB (=64 MiB×128).

In the configuration example of the multilevel L2P table 7 illustrated in FIG. 6, the access ranges (capacities) covered by one data portion may satisfy the following relationship:

Type-2 L1 L2P table>Type-1 L2 L2P table>Type-1 L1 L2P table

That is, the type-2 L1 L2P table 81 may have a greatest access range (capacity) covered by one data portion (one cache line), and the type-1 L2 L2P table 72′ may have a second greatest access range covered by one data portion. The type-1 L1 L2P table 71′ may have a smallest access range covered by one data portion.

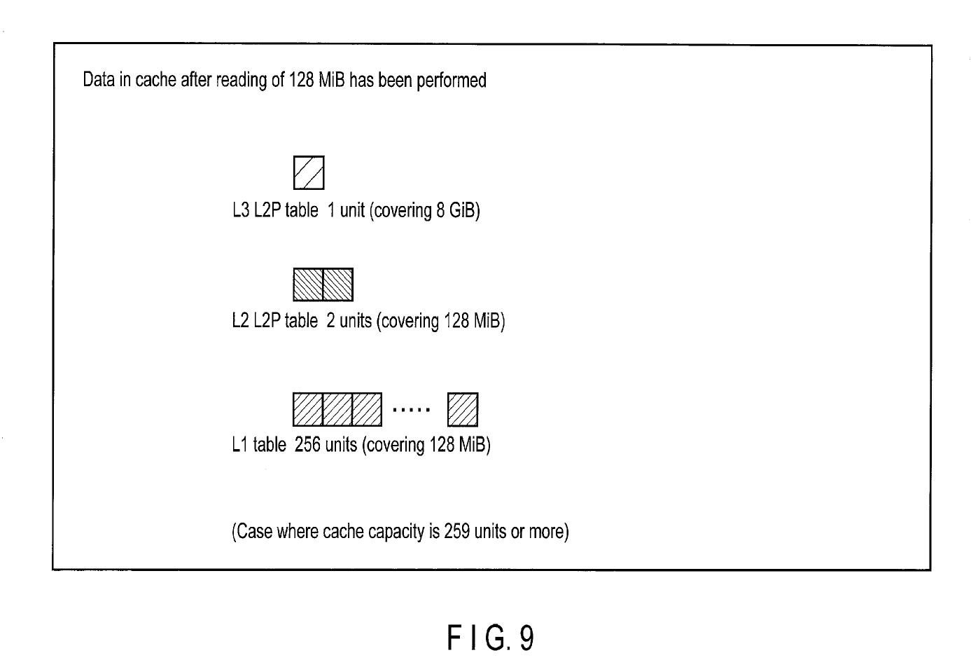

FIG. 9 shows by what ratio the data portions of the tables 71, 72 and 73 are retained in the L2P table cache 131, after read accesses (for example, random reads) distributed in a range of 128 MiB (namely, an LBA range with a capacity of 128 MiB) are executed.

In the L3 L2P table 73, one data portion (one unit) covers an access range of 8 GiB. This means that the L3 L2P table 73 requires only one data portion for executing plural read accesses (for example, random reads) distributed within the range of 128 MiB. Therefore, for the L3 L2P table 73, only one data portion is loaded from the NAND memory 5 to the L2P table cache 131.

In the L2 L2P table 72, one data portion (one unit) covers an access range of 64 MiB. Accordingly, the total of data portions of the L2 L2P table 72 required for the execution of the plural read accesses distributed within the range of 128 MiB is two. The total access range covered by the two data portions of the L2 L2P table 72 is 128 MiB. Therefore, for the L2 L2P table 72, two data portions are loaded from the NAND memory 5 to the L2P table cache 131.

In the L1 L2P table 71, an access range of 512 KiB is covered by one data portion (one unit). Accordingly, the total of data portions of the L1 L2P table 71 required for the execution of the plural read accesses distributed within the range of 128 MiB is 256. The total access range covered by the 256 data portions of the L1 L2P table 71 is 128 MiB. Therefore, for the L1 L2P table 71, 256 data portions are loaded from the NAND memory 5 to the L2P table cache 131.

Therefore, if the L2P table cache 131 has a capacity of not less than 259 units (namely, 259 cache lines), it can retain the data portions of the L1 L2P table 71, the L2 L2P table 72 and the L3 L2P table 73 with such a ratio as shown in FIG. 9. When the L2P table cache 131 is set in the state shown in FIG. 9, all logical-to-physical address translations required for these read accesses can be performed at high speed by only accessing (referring to) the L2P table cache 131.

The L2P table cache 131 has a certain restricted capacity. Therefore, it is not always possible to retain, in the L2P table cache 131, all data portions (all logical-to-physical address translation information) required for these read accesses.

For example, in a case where the host 2 executes read accesses (for example, random reads) distributed within a certain wide range, a greater number of cache lines may be evicted because of shortage of the capacity of the L2P table cache 131.

More specifically, whenever a new data portion required for logical-to-physical address translation is loaded from the multilevel L2P table 7 in the NAND memory 5 to the L2P table cache 131, replacement processing for evicting one of the cache lines may be performed. As a result, a greater part of the capacity of the L2P table cache 131 may be occupied by many data portions newly loaded, which may accelerate eviction of data portions that can be used repeatedly for logical-to-physical address translation of this access range.

In the embodiment, the controller 4 performs new cache control for enhancing as far as possible the hit ratio of the L2P table cache 131 that has a restricted capacity.

More specifically, the controller 4 executes control for evicting, from the L2P table cache 131, respective cache lines storing the data portions of a table whose access range (capacity) covered by one data portion (one cache line) is narrow, in preference to respective cache lines storing the data portions of a table whose access range (capacity) covered by one data portion (one cache line) is wide.

By preferentially evicting the data portions of the table whose access range (capacity) covered by one data portion (one cache line) is narrow, the data portions of the table whose access range (capacity) covered by one data portion (one cache line) is wide can be preferentially retained in the L2P table cache 131.

Therefore, even in a case where shortage of capacity of the L2P table cache 131 has occurred because the host 2 has performed read accesses of a wide access range, reduction of the hit ratio of the L2P table cache 131 can be sufficiently suppressed.

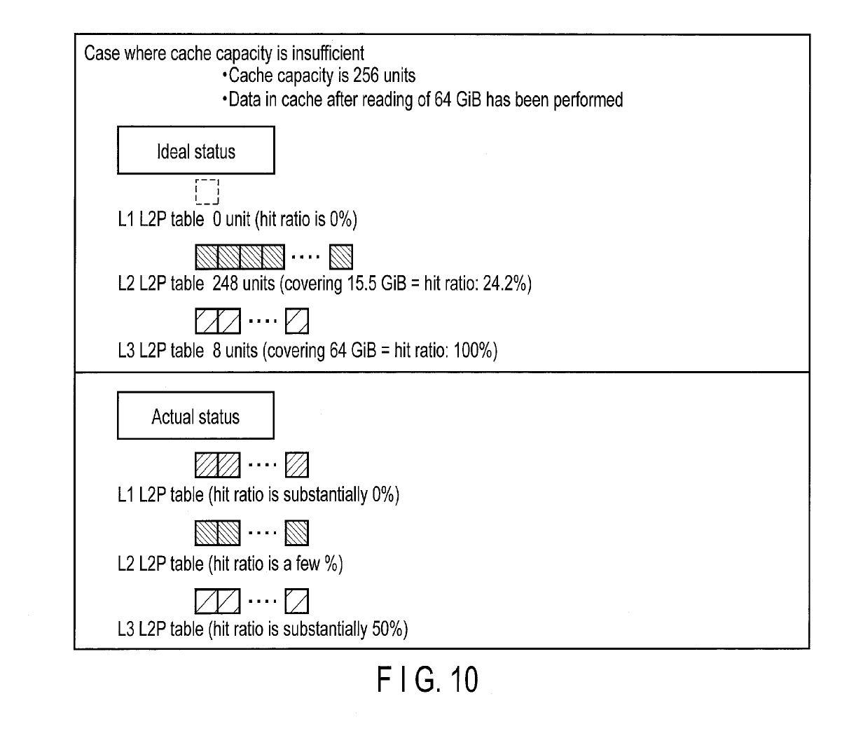

FIG. 10 shows in what ratio the data portions of tables 71, 72 and 73 are retained in the L2P table cache 131, after a plurality of read accesses distributed in a certain wide range (address range) are executed.

Assume here that the capacity of the L2P table cache 131 is 256 units (namely, 256 cache lines), and a plurality of read accesses (for example, random reads) distributed within a range of 64 GiB (namely, an LBA range with a capacity of 64 GiB) have been executed.

The upper part of FIG. 10 shows an example of an ideal ratio of the data portions of tables 71, 72 and 73 retained in the L2P table cache 131. Further, the lower part of FIG. 10 shows an example of an actual ratio of the data portions of tables 71, 72 and 73 retained in the L2P table cache 131, assumed when normal cache control of equally selecting the various types of tables as a replacement candidate has been performed.

Referring first to the upper part of FIG. 10, a description will be given of the ideal ratio of the data portions of tables 71, 72 and 73 retained in the L2P table cache 131.

In the L3 L2P table 73, one data portion (one unit) covers an access range of 8 GiB as mentioned above. Accordingly, the total of data portions of the L3 L2P table 73 required for execution of the logical-to-physical address translation for the plural read accesses distributed within the range of 64 GiB is eight. The total access range covered by the eight data portions of the L3 L2P table 73 is 64 GiB. Therefore, for the L3 L2P table 73, it is desirable that all eight data portions are retained in the L2P table cache 131.

If all these eight data portions of the L3 L2P table 73 are stored in the L2P table cache 131, the hit ratio of the L3 L2P table 73 can be made 100%.

In the L2 L2P table 72, as mentioned above, the access range of 64 MiB is covered by one data portion (one unit). Since the remaining capacity of the L2P table cache 131 is 248 units (=256−8), if 248 data portions of the L2 L2P table 72 are retained in the L2P table cache 131, an access range of 15.5 GiB can be covered by the 248 data portions. In this case, the hit ratio of the L2 L2P table 72 can be made 24.2%.

In the L1 L2P table 71, one data portion (one unit) can cover only an access range of 512 KiB. Because of this, when a wide address range is accessed by the host 2, even if the number of data portions of the L1 L2P table 71 retained in the L2P table cache 131 has increased, the hit ratio of the L1 L2P table 71 may be substantially 0%. Further, if the number of data portions of the L1 L2P table 71 retained in the L2P table cache 131 has increased, the number of data portions of the other tables that can be retained in the L2P table cache 131, namely, the number of data portions of the L3 L2P table 73 and the number of data portions of the L2 L2P table 72, are inevitably decreased, with the result that the hit ratio of the whole L2P table cache 131 may be decreased.

In light of the above, the number of data portions of the L1 L2P table 71 held in the L2P table cache 131 may be substantially zero. This can suppress waste of the capacity of the L2P table cache 131 due to the low-hit data portions of the L1 L2P table 71, that is, can suppress acceleration of eviction of the data portions of the high-hit L3 L2P table 73 (or L2 L2P table 72), which is caused by the occupation of the L2P table cache 131 by the data portions of the L1 L2P table 71.

In the embodiment, the controller 4 can execute cache line eviction in consideration of an access range (also called a cover access range) to be covered by one data portion of each of different types of tables, instead of equally treating all tables as replacement targets. More specifically, the controller 4 evicts, from the L2P table cache 131, a cache line storing one of data portions of the L1 L2P table 71, in preference to each of the cache lines storing the respective data portions of the L2 L2P table 72 and the L3 L2P table 73. Further, the controller 4 evicts, from the L2P table cache 131, a cache line storing one of data portions of the L2 L2P table 72, in preference to each of the cache lines storing the respective data portions of the L3 L2P table 73.

According to this cache control, even if shortage has occurred in the capacity of the cache, the probability of eviction of each data portion of the L3 L2P table 73, that is, the possibility of selection of each data portion of the L3 L2P table 73 as a replacement target cache line, can be suppressed low. Similarly, the probability of eviction of each data portion of the L2 L2P table 72 can be suppressed relatively low.

Thus, the possibility that each data portion of the L3 L2P table 73 will remain in the L2P table cache 131 is strongest. Further, the possibility that each data portion of the L2 L2P table 72 will remain in the L2P table cache 131 is stronger than that of the data portions of the L1 L2P table 71. Thus, the cache control of the embodiment can realize a situation close to that shown in the upper part of FIG. 10.

Referring then to the lower part of FIG. 10, a description will be given of an example of an actual ratio between the data portions of tables 71, 72 and 73 retained in the L2P table cache 131, assumed when normal cache control of equally selecting the various types of tables as replacement targets.

When plural read accesses (for example, random reads) distributed in a certain wide range (wide address range) are performed, cache misses will easily occur, and a cache line is replaced whenever a cache miss occurs.

As a result, the number of data portions of the L1 L2P table 71 retained in the L2P table cache 131, the number of data portions of the L2 L2P table 72 retained in the L2P table cache 131, and the number of data portions of the L3 L2P table 73 retained in the L2P table cache 131, may be substantially equal. This is because these various types of tables will be equally selected as replacement targets.

In this case, many data portions of the L1 L2P table 71 that is hardly hit will occupy a greater part of the capacity of the L2P table cache 131. This may well reduce the hit ratio of the whole L2P table cache 131.

In the embodiment, cache control processing of preferentially evicting the data portions of a table having a narrow cover access range is performed. This suppresses occurrence of a state in which the number of data portions of the L1 L2P table 71 retained in the L2P table cache 131, the number of data portions of the L2 L2P table 72 retained in the L2P table cache 131, and the number of data portions of the L3 L2P table 73 retained in the L2P table cache 131, are substantially equal.

Some examples of the cache control processing for preferentially evicting the data portions of a table having a narrow cover access range will be described.

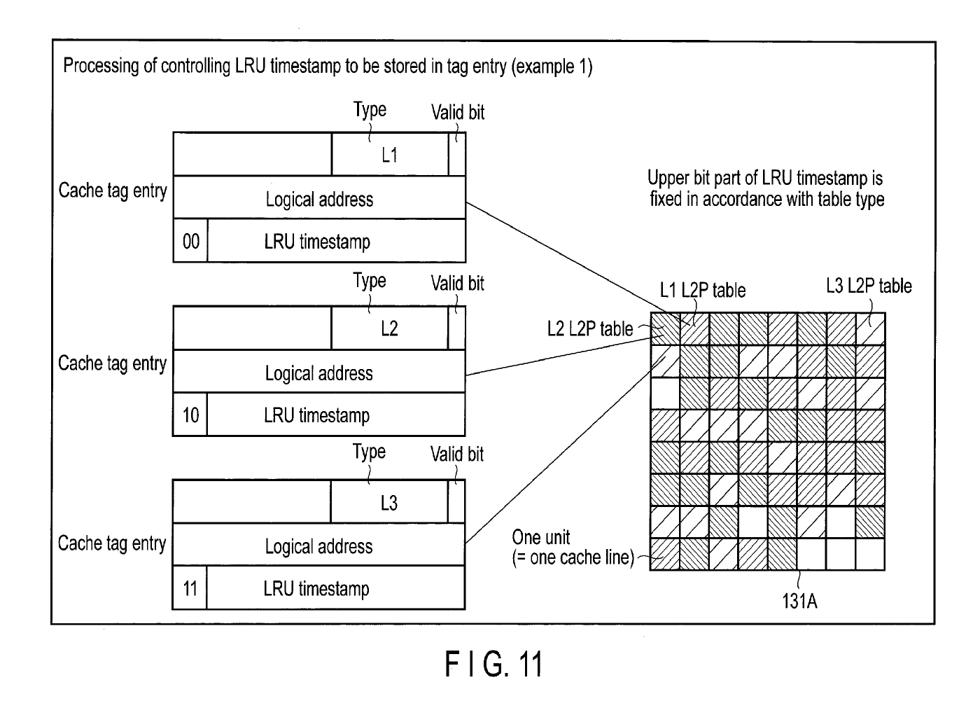

FIG. 11 shows first LRU-timestamp control processing executed by the controller 4.

As described above, each tag entry stores an LRU timestamp used to select a replacement target cache line based on an LRU policy. When one of the cache lines is to be replaced because of a cache miss of the L2P table cache 131, processing of selecting a replacement target cache line is performed. In the processing of selecting a replacement target cache line, LRU timestamps corresponding to respective replacement target cache-line candidates are compared. Among the replacement target cache-line candidates, a replacement target cache-line candidate having the lowest LRU timestamp may be selected as a replacement target cache line. The cache line selected as a replacement target cache line is evicted. Then, the data in this cache line is discarded.

If the L2P table cache 131 is a fully associative cache, all cache lines in the L2P table cache 131 are regarded as replacement target cache-line candidates. In this case, the controller 4 may read LRU timestamps from all tag entries corresponding to all cache lines, and may compare the LRU timestamps to select a replacement target cache line. In contrast, if the L2P table cache 131 is an n-way set associative cache, n ways (n>=2) corresponding to a certain specific set are replacement target cache-line candidates. In this case, the controller 4 may read n LRU timestamps from n tag entries corresponding to the n ways, and may compare the n LRU timestamps to select a replacement target cache line.

When the LRU timestamp of a certain tag entry should be updated, the controller 4 executes processing of fixing, to a particular value, the upper bit portion of a new timestamp to be stored in the tag entry in accordance with the table type of a data portion stored in a cache line corresponding to the tag entry.

As described above, update of a timestamp corresponding to a certain cache line is performed for each access of this cache line. In more detail, update of a timestamp corresponding to a certain cache line may be performed when a cache hit has occurred in this cache line, and also when a new data portion is loaded to the cache line.

The following timestamp update processing may be performed at the time of a cache hit.

When a desired data portion of the L1 L2P table 71 exists in the L2P table cache 131 (a cache hit associated with the L1 L2P table 71), the controller 4 updates the LRU timestamp corresponding to the cache line that stores the desired data portion, to a current counter value (latest counter value) generated by an LRU counter. This LRU counter may be an above-mentioned serial counter. The current counter value generated by the LRU counter may be expressed using a plurality of bits. The current counter value may be obtained by incrementing a preceding counter value by, for example, +1.

The controller 4 may first fix only the upper bit part (for example, upper two bits) of a plurality of bits representing the current counter value to a first value (for example, “00”), and store, as a new LRU timestamp in the tag entry, the current counter value having the upper bit part (for example, the upper two bits) fixed at the first value (for example, “00”). As a result, the LRU timestamp already stored in the tag entry is updated to a value obtained by fixing only the upper bit part (for example, the upper two bits) of the current counter value at the first value (for example, “00”).

When a desired data portion of the L2 L2P table 72 exists in the L2P table cache 131 (a cache hit associated with the L2 L2P table 72), the controller 4 may update an LRU timestamp corresponding to a cache line that stores the desired data portion, to a value obtained by fixing, to a second value (for example, “10”) greater than the first value, only the upper bit part (for example, the upper two bits) of a plurality of bits that represent a current counter value generated by the LRU counter.

When the desired data portion of the L3 L2P table 73 exists in the L2P table cache 131 (a cache hit associated with the L3 L2P table 73), the controller 4 may update an LRU timestamp corresponding to a cache line that stores the desired data portion, to a value obtained by fixing, to a third value (for example, “11”) greater than the second value, only the upper bit part (for example, the upper two bits) of a plurality of bits that represent a current counter value generated by the LRU counter.

As a result, LRU timestamps corresponding to the respective data portions of the L1 L2P table 71 are less than LRU timestamps corresponding to the data portions of the other tables. Further, LRU timestamps corresponding to the respective data portions of the L3 L2P table 73 are greater than LRU timestamps corresponding to the data portions of the other tables. Furthermore, LRU timestamps corresponding to the respective data portions of the L2 L2P table 72 fall within a range between the range of the LRU timestamps corresponding to the respective data portions of the L1 L2P table 71, and the range of the LRU timestamps corresponding to the respective data portions of the L3 L2P table 73.

The controller 4 evicts, from the L2P table cache 131, a cache line (a cache line including the oldest data portion) that is included in the replacement target cache-line candidates and associated with the lowest LRU timestamp.

As a result, each data portion of the L1 L2P table 71 can be evicted from the L2P table cache 131 in preference to the data portions of the other tables. Similarly, each data portion of the L2 L2P table 72 can be evicted from the L2P table cache 131 in preference to the data portions of the L3 L2P table 73.

Also when a new data portion has been stored in a cache line, an LRU timestamp corresponding to this cache line is updated in the same procedure as in the case where a cache hit has occurred in the cache line.

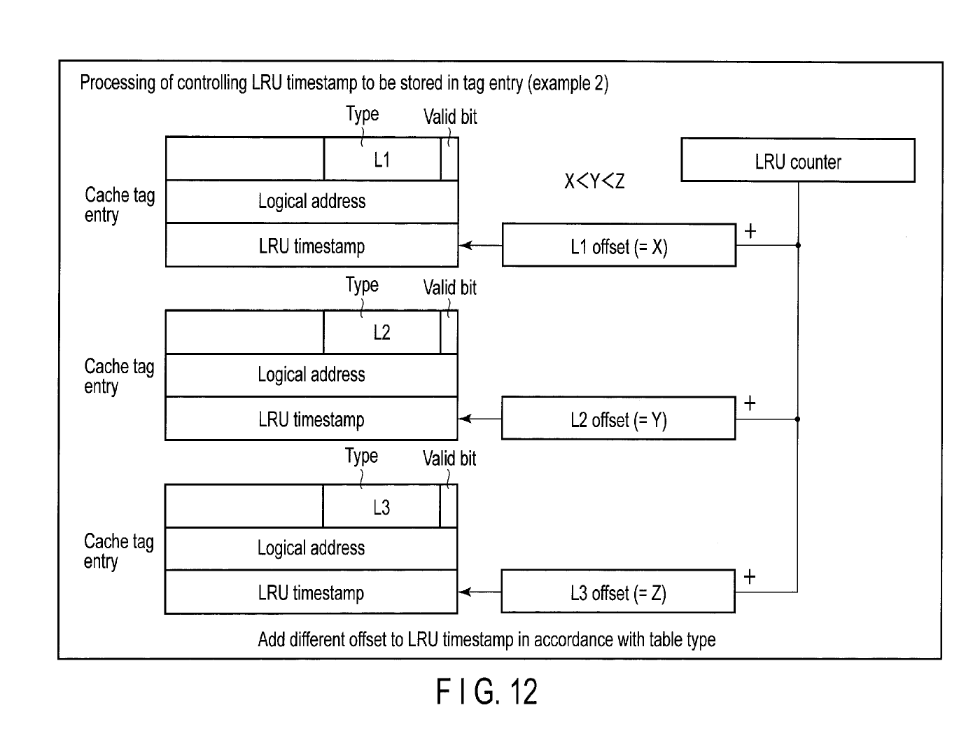

FIG. 12 shows second LRU-timestamp control processing executed by the controller 4.

When the LRU timestamp of a certain tag entry should be updated, the controller 4 may add, to a current counter value of the LRU counter, a different value (different offset), in accordance with the table type of a data portion stored in a cache line corresponding to this tag entry.

At the time of a cache hit, the following timestamp update processing may be performed:

If a desired data portion of the L1 L2P table 71 exists in the L2P table cache 131 (a cache hit associated with the L1 L2P table 71), the controller 4 may update an LRU timestamp corresponding to the cache line to a value obtained by adding a first offset (for example, “X”) to the current counter value generated by the LRU counter. As an example of “X”, a value not less than zero may be used.

When a desired data portion of the L2 L2P table 72 exists in the L2P table cache 131 (a cache hit associated with the L2 L2P table 72), the controller 4 may update an LRU timestamp corresponding to the cache line to a value obtained by adding a second offset (for example, “Y”) greater than the first offset to the current counter value generated by the LRU counter.

When a desired data portion of the L3 L2P table 73 exists in the L2P table cache 131 (a cache hit associated with the L3 L2P table 73), the controller 4 may update an LRU timestamp corresponding to the cache line to a value obtained by adding a third offset (for example, “Z”) greater than the second offset to the current counter value generated by the LRU counter.

In the processing of selecting a replacement target cache line, the controller 4 evicts, from the L2P table cache 131, a cache line (a cache line including the oldest data portion) that is included in the replacement target cache-line candidates and associated with the lowest LRU timestamp.

Therefore, by pre-setting “X,” “Y” and “Z” appropriately, the cache line storing the data portion of the L1 L2P table 71 can be evicted in preference to the cache lines storing the data portions of the L2 L2P table 72 and the cache lines storing the data portions of the L3 L2P table 73. Furthermore, the cache lines storing the data portions of the L2 L2P table 72 can be evicted in preference to the cache lines storing the data portions of the L3 L2P table 73.

Also when a new data portion has been stored in a certain cache line, an LRU timestamp corresponding to this cache line is updated in the same procedure as in the case where a cache hit has occurred in the cache line.

There are cases where the host 2 executes a plural read accesses (for example, random reads) distributed in a narrow address range, after once executing a plural read accesses (for example, random reads) distributed in a wide address range. When the workload of data reads is thus shifted from a status in which reading is executed in a wide address range, to a status in which reading is executed in a narrow address range, the data portions of the L3 L2P table 73, which are no longer used for logical-to-physical address translation, may keep to remain in the L2P table cache 131.

In the above-described second timestamp control processing, the value of the timestamp corresponding to each of the data portions of the L1 L2P table 71 increases as access (load/cache hit) to each data portion of the L1 L2P table 71 is repeated over time. In contrast, the value of the timestamp corresponding to each data portion of the L3 L2P table 73 no longer used for address translation is not updated even after time elapses.

Therefore, in the case where the workload of data reads is shifted from a status in which reading is executed in a wide address range, to a status in which reading is executed in a narrow address range, the value of the timestamp corresponding to each data portion of the L1 L2P table 71 may become greater over time than the value of the timestamp corresponding to each data portion of the L3 L2P table 73.

Since thus, data portion of the L3 L2P table 73 no longer used for address translation can be evicted, the content of a corresponding cache line can be replaced by a data portion of the L1 L2P table 71 loaded from the NAND memory 5.

Accordingly, in the second timestamp control processing, the ratio of the data portions of different types of tables retained in the L2P table cache 131 can be adaptively controlled in accordance with the size of the range of access by the host 2. This adaptive control of the ratio of data portions enables the data portions of different types of tables to be retained in the L2P table cache 131 with a ratio (for example, an appropriate ratio as shown in FIG. 9) that can provide a high hit ratio, even after the address range is shifted from a wide range to a narrow range.

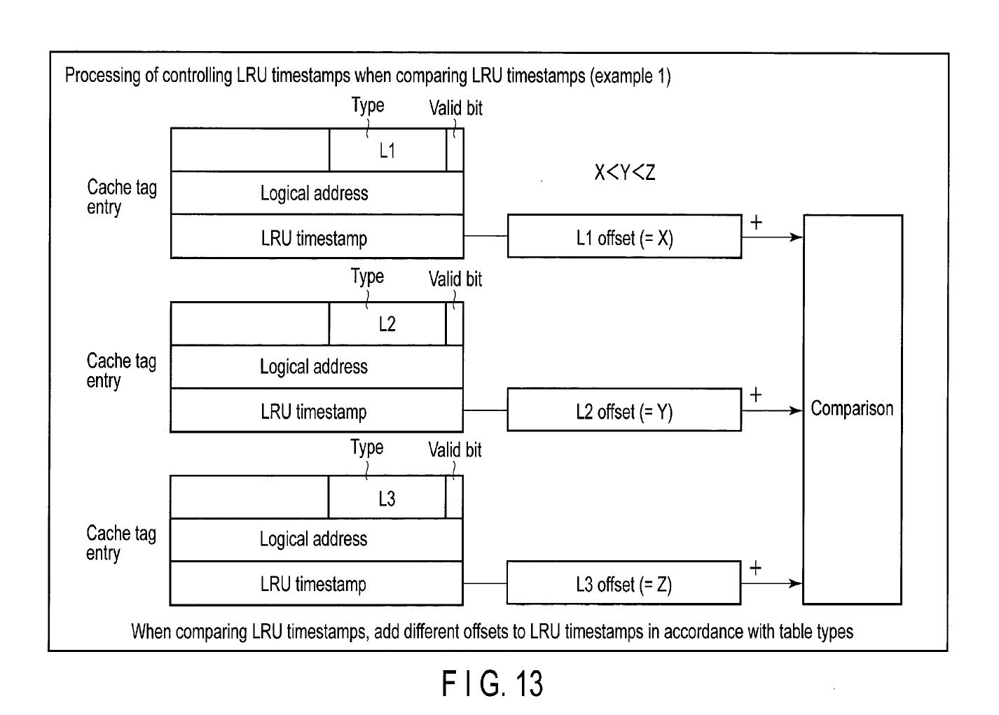

FIG. 13 shows third timestamp control processing executed by the controller 4.

In the third timestamp control processing, each tag entry stores a normal LRU timestamp. The value of the normal LRU timestamp may be a current counter value itself generated by the LRU counter. When LRU timestamps read from tag entries are compared for selecting a replacement target cache line, offsets that differ among different table types are added to the LRU timestamps.

When a cache miss has occurred, the following timestamp comparison processing may be performed for selecting a replacement target cache line:

The controller 4 reads LRU timestamps from the tag entries of respective replacement target cache line candidates. After that, the controller 4 may add, to each read LRU timestamp, the above-mentioned first offset (for example, “X”), the above-mentioned second offset (for example, “Y”), or the above-mentioned third offset (for example, “Z”).

In this case, “X” is added to LRU timestamps corresponding to cache lines that store the respective data portions of the L1 L2P table 71. Similarly, “Y” is added to LRU timestamps corresponding to cache lines that store the respective data portions of the L2 L2P table 72. “Z” is added to LRU timestamps corresponding to cache lines that store the respective data portions of the L3 L2P table 73.

Further, the controller 4 may compare LRU timestamps to each of which “X,” “Y” or “Z” is added, and may select, as a replacement target cache line, a cache line associated with the lowest LRU timestamp.

Thus, the same advantage (including adaptive control of the ratio of data portions) as the second timestamp control processing can be acquired.

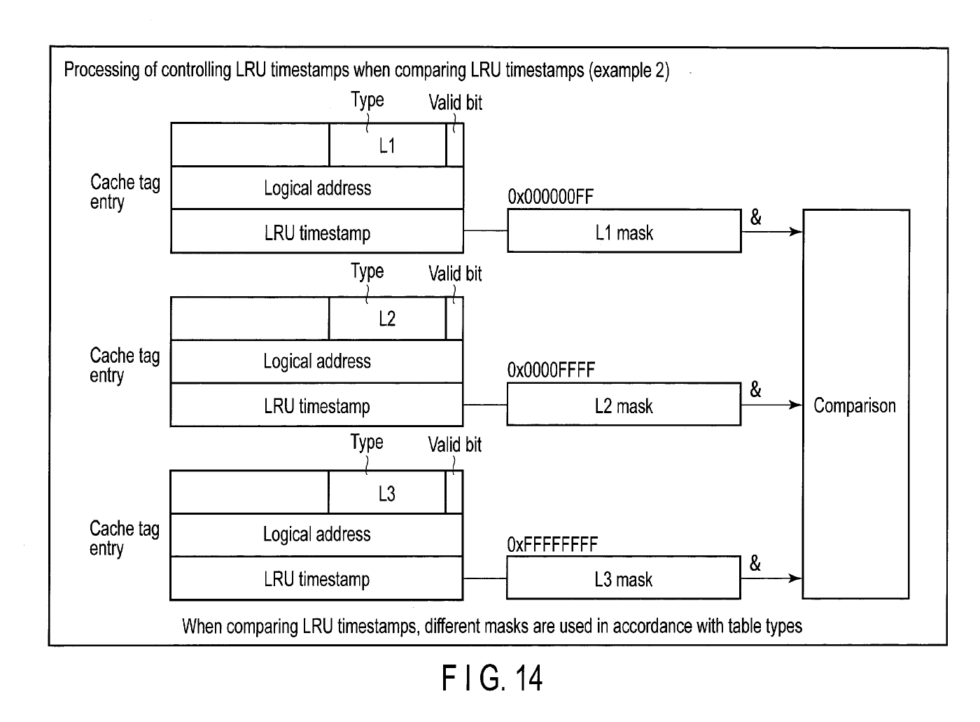

FIG. 14 shows fourth timestamp control processing performed by the controller 4.

In the fourth timestamp control processing, a normal LRU timestamp (for example, the current counter value generated by the LRU counter) is stored in each tag entry. When LRU timestamps read from tag entries are compared for selecting a replacement target cache line, masks that differ among different table types are applied to the LRU timestamps.

When a cache miss has occurred, the following timestamp comparison processing may be performed for selecting a replacement target cache line:

The controller 4 reads LRU timestamps from the tag entries of respective replacement target cache-line candidates. After that, the controller 4 masks a plurality of bits that represent each of the read LRU timestamps, using a first mask pattern (L1 mask), a second mask pattern (L2 mask), or a third mask pattern (L3 mask).

The first mask pattern (L1 mask) may be a mask pattern (for example, 0x000000FF) for masking an upper bit part having a first bit width. In this pattern, “0x” represents hexadecimal notation. The second mask pattern (L2 mask) may be a mask pattern (for example, 0x0000FFFF) for masking an upper bit part having a second bit width narrower than the first bit width. The third mask pattern (L3 mask) may be a mask pattern (for example, 0xFFFFFFFF) for masking an upper bit part having a third bit width narrower than the second bit width.

The first mask pattern (L1 mask) is used to mask each of LRU timestamps corresponding to cache lines that store respective data portions of the L1 L2P table 71. The second mask pattern (L2 mask) is used to mask each of LRU timestamps corresponding to cache lines that store respective data portions of the L2 L2P table 72. The third mask pattern (L3 mask) is used to mask each of LRU timestamps corresponding to cache lines that store respective data portions of the L3 L2P table 73.

As a result, at the time of comparing LRU timestamps, the LRU timestamp corresponding to each data portion of the L3 L2P table 73 will be greater than the LRU timestamps corresponding to the data portions of the other tables. Similarly, the LRU timestamp corresponding to each data portion of the L2 L2P table 72 will be greater than the LRU timestamp corresponding to each data portion of the L1 L2P table 71.

Further, the controller 4 may compare the LRU timestamps masked by the mask patterns, and may select, as a replacement target cache line, a cache line associated with the lowest LRU timestamp.

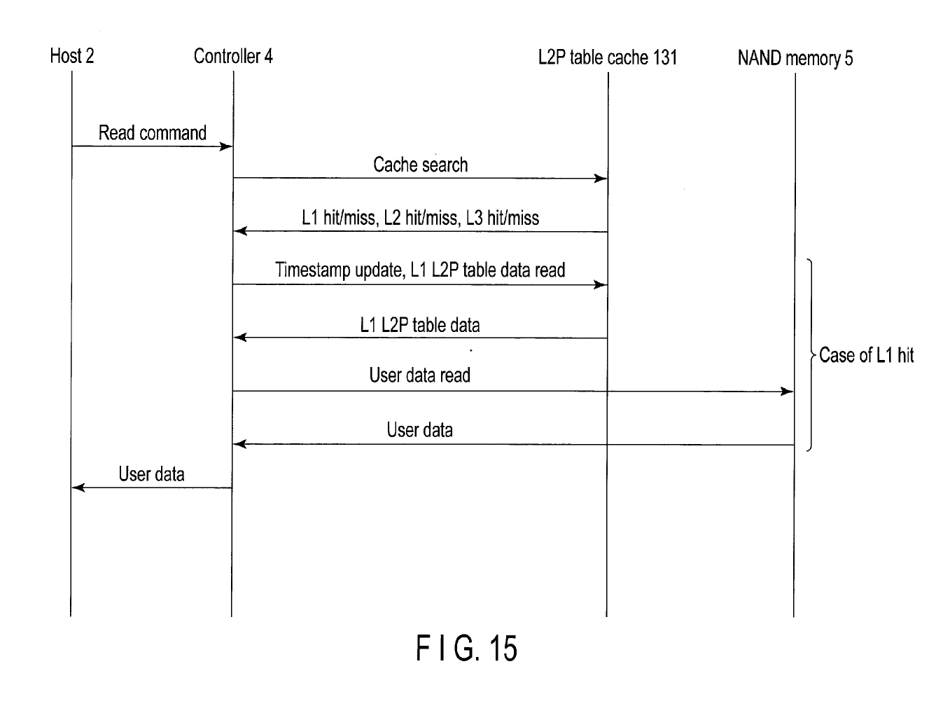

FIG. 15 shows a sequence of cache control processing performed by the controller 4 when a cache hit associated with the L1 L2P table has occurred during data reading.

The host 2 sends a read command to the SSD 3. When the controller 4 of the SSD 3 has received the read command from the host 2, the controller 4 searches the L2P table cache 131 (cache tag 131B), thereby determining whether a desired data portion (address translation information) required to translate a logical address (LBA) designated by the read command into a physical address exists in the L2P table cache 131. In the search of the L2P table cache 131, the controller 4 refers to the cache tag 131B, thereby determining whether the desired data portion (address translation information) exists in the cache body 131A of the L2P table cache 131.

In the first-stage address translation, this desired data portion is a certain data portion of the L3 L2P table 73 corresponding to the logical address. In the next-stage address translation, the desired data portion is a certain data portion of the L2 L2P table 72 corresponding to the logical address. In the last-stage (third-stage) address translation, the desired data portion is a certain data portion of the L1 L2P table 71 corresponding to the logical address.

Since an address range covered by each data portion of the L1 L2P table 71 required for the last-stage address translation is narrow as mentioned above, the probability that the desired data portion of the L1 L2P table 71 required for the logical-to-physical address translation will exist in the L2P table cache 131 is low. However, if the desired data portion of the L1 L2P table 71 exists in the L2P table cache 131 (a cache hit associated with the L1 L2P table 71), the last-stage logical-to-physical address translation can be executed even when the desired data portions of the other tables does not exist in the L2P table cache 131. This is because the desired data portion of the L1 L2P table 71 is already loaded to the L2P table cache 131, and therefore can be referred to without utilizing a location in the NAND memory 5 where the desired data portion of the L1 L2P table 71 is stored.

The controller 4 may first determine cache hits and cache misses associated with all desired data portions of three types, that is, may determine a cache hit/cache miss associated with the L1 L2P table 71, a cache hit/cache miss associated with the L2 L2P table 72, and a cache hit/cache miss associated with the L3 L2P table 73.

A cache hit (L1 hit) associated with the L1 L2P table 71 represents a state where a desired data portion of the L1 L2P table 71 necessary for logical-to-physical address translation of the logical address exists in the L2P table cache 131. A cache miss associated with the L1 L2P table 71 represents a state where the desired data portion of the L1 L2P table 71 necessary for logical-to-physical address translation of the logical address does not exist in the L2P table cache 131.

That is, the cache hit associated with the L1 L2P table 71 represents a state where a tag entry including a tag address identical to the upper bit part (L1 tag address) of a logical address designated by a read command exists, and the type field of the tag entry indicates the L1 L2P table 71.

A cache hit (L2 hit) associated with the L2 L2P table 72 represents a state where a desired data portion of the L2 L2P table 72 necessary for logical-to-physical address translation of the logical address exists in the L2P table cache 131. A cache miss associated with the L2 L2P table 72 represents a state where the desired data portion of the L2 L2P table 72 necessary for logical-to-physical address translation of the logical address does not exist in the L2P table cache 131.

That is, the cache hit associated with the L2 L2P table 72 represents a state where a tag entry including a tag address identical to the upper bit part (L2 tag address) of a logical address designated by a read command exists, and the type field of the tag entry indicates the L2 L2P table 72.

A cache hit (L3 hit) associated with the L3 L2P table 73 represents a state where a desired data portion of the L3 L2P table 73 necessary for logical-to-physical address translation of the logical address exists in the L2P table cache 131. A cache miss associated with the L3 L2P table 73 represents a state where the desired data portion of the L3 L2P table 73 necessary for logical-to-physical address translation of the logical address does not exist in the L2P table cache 131.

That is, the cache hit associated with the L3 L2P table 73 represents a state where a tag entry including a tag address identical to the upper bit part (L3 tag address) of a logical address designated by a read command exists, and the type field of the tag entry indicates the L3 L2P table 73.

When a cache hit associated with the L1 L2P table 71 has occurred, the controller 4 updates an LRU timestamp corresponding to a cache line that stores the desired data portion of this L1 L2P table 71. If a cache hit associated with the L2 L2P table 72 has simultaneously occurred, the controller 4 may also update an LRU timestamp corresponding to a cache line that stores the desired data portion of the L2 L2P table 72. Similarly, if a cache hit associated with the L3 L2P table 73 has simultaneously occurred, the controller 4 may also update an LRU timestamp corresponding to a cache line that stores the desired data portion of the L3 L2P table 73.

The controller 4 reads the desired data portion (L1 L2P table data) of the L1 L2P table 71 from the L2P table cache 131. After that, the controller 4 extracts, from the read L1 L2P table data, a physical address designated by subfield 200D of the logical address. The controller 4 accesses the NAND memory 5 using the physical address, thereby reading, from the NAND memory 5, user data designated by the logical address in the read command. The controller 4 transmits the read user data to the host 2.

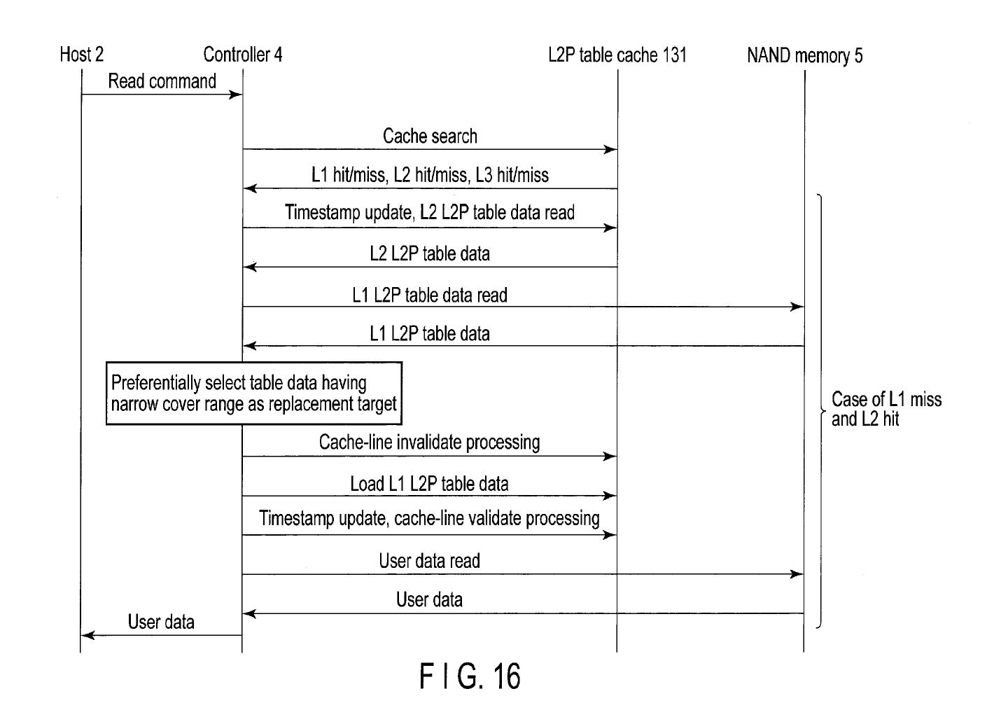

FIG. 16 shows a sequence of cache control processing performed by the controller 4 when a cache miss associated with the L1 L2P table and a cache hit associated with the L2 L2P table have occurred during data reading.

The host 2 sends a read command to the SSD 3. When the controller 4 of the SSD 3 has received the read command from the host 2, the controller 4 may search the L2P table cache 131 (cache tag 131B), thereby determining a cache hit/cache miss associated with the L1 L2P table 71, a cache hit/cache miss associated with the L2 L2P table 72, and a cache hit/cache miss associated with the L3 L2P table 73.

If a cache miss associated with the L1 L2P table 71 has occurred and a cache hit associated with the L2 L2P table 72 has occurred, the controller 4 updates an LRU timestamp corresponding to a cache line that stores a desired data portion of this L2 L2P table 72. If at this time, a cache hit associated with the L3 L2P table 73 has also occurred, the controller 4 may also update an LRU timestamp corresponding to a cache line that stores a desired data portion of this L3 L2P table 73.

The controller 4 reads the desired data portion (L2 L2P table data) of the L2 L2P table 72 from the L2P table cache 131. After that, the controller 4 extracts, from the read L2 L2P table data, an address designated by subfield 200C of the logical address. The controller 4 accesses the NAND memory 5 using this address, thereby reading the desired data portion (L1 L2P table data) of the L1 L2P table 71 from the NAND memory 5.

The controller 4 refers to the cache tag 131B, thereby searching for an invalid cache line. If such an invalid cache line exists, the controller 4 may select this invalid cache line as a replacement target cache line.

In contrast, if no invalid cache line exists, the controller 4 may select a replacement target cache line from valid cache lines, using the LRU timestamps of the valid cache lines. At this time, a cache line storing a data portion of a table that has a small access range covered by one data portion (one cache line) is selected preferentially as the replacement target cache line. After that, the controller 4 evicts the cache line selected as the replacement target cache line, by changing a valid bit corresponding to the cache line selected as the replacement target cache line to a value (for example, “0”) that indicates invalidity.

The controller 4 stores (loads) the L1 L2P table data read from the NAND memory 5 in (to) the cache line selected as the replacement target cache line. The controller 4 updates an LRU timestamp corresponding to the cache line to which the L1 L2P table data read from the NAND memory 5 has been loaded. Subsequently, the controller 4 validates this cache line by changing the valid bit corresponding to the cache line to a value (for example, “1”) that indicates validity.

The controller 4 extracts, from the L1 L2P table data read from the NAND memory 5, a physical address designated by subfield 200D of the logical address. The controller 4 accesses the NAND memory 5 using the physical address, thereby reading user data designated by the logical address in the read command. The controller 4 transmits the read user data to the host 2.

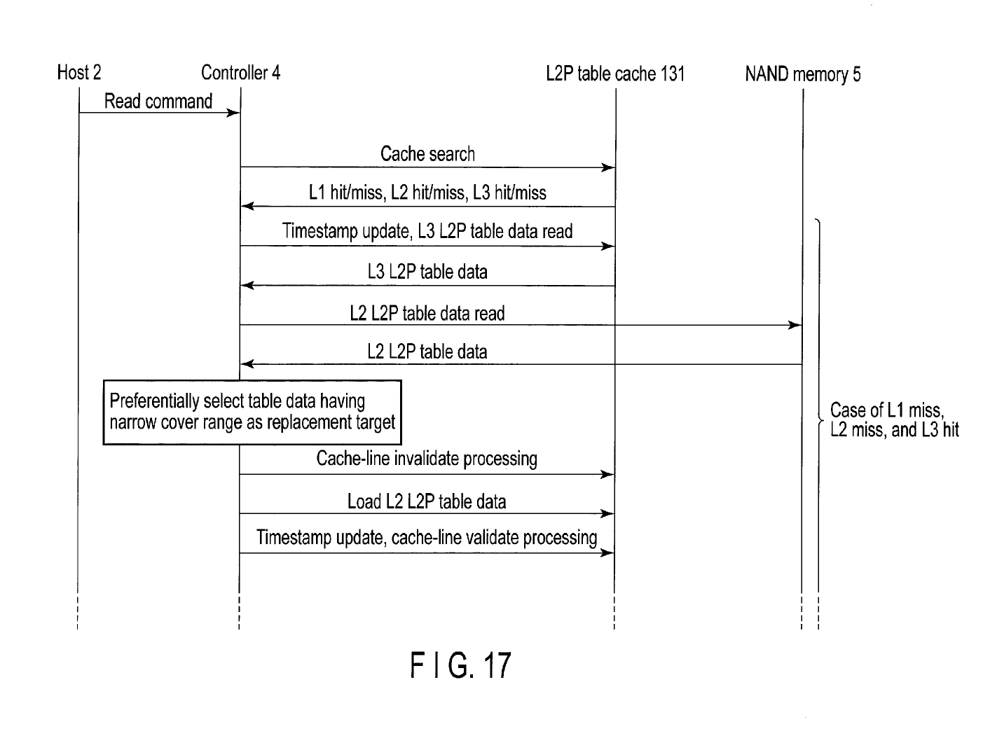

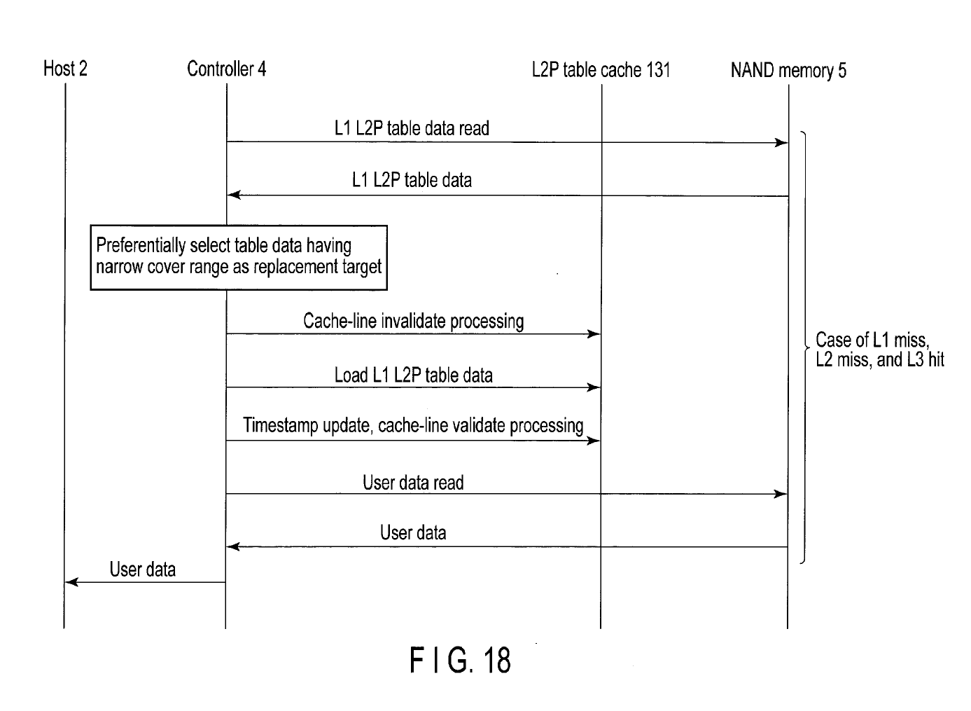

FIG. 17 and FIG. 18 show a sequence of cache control processing performed by the controller 4 when a cache miss associated with the L1 L2P table, a cache miss associated with the L2 L2P table, and a cache hit associated with the L3 L2P table have occurred during data reading.

The host 2 sends a read command to the SSD 3. When the controller 4 of the SSD 3 has received the read command from the host 2, the controller 4 may search the L2P table cache 131 (cache tag 131B), thereby determining a cache hit/cache miss associated with the L1 L2P table 71, a cache hit/cache miss associated with the L2 L2P table 72, and a cache hit/cache miss associated with the L3 L2P table 73.

If a cache miss associated with the L1 L2P table 71 has occurred, a cache miss associated with the L2 L2P table 72 has occurred, and a cache hit associated with the L3 L2P table 73 has occurred, the controller 4 updates an LRU timestamp corresponding to a cache line that stores a desired data portion of this L3 L2P table 73.

The controller 4 reads the desired data portion (L3 L2P table data) of the L3 L2P table 73 from the L2P table cache 131. After that, the controller 4 extracts, from the read L3 L2P table data, an address designated by subfield 200B of the logical address. The controller 4 accesses the NAND memory 5 using this address, thereby reading the desired data portion (L2 L2P table data) of the L2 L2P table 72 from the NAND memory 5.

The controller 4 refers to the cache tag 131B, thereby searching for an invalid cache line. If such an invalid cache line exists, the controller 4 may select the invalid cache line as a replacement target cache line.

In contrast, if no invalid cache line exists, the controller 4 may select a replacement target cache line from valid cache lines, using the LRU timestamps of the valid cache lines. At this time, a cache line storing a data portion of a table that has a small access range covered by one data portion (one cache line) is selected preferentially as the replacement target cache line. After that, the controller 4 invalidates the cache line selected as the replacement target cache line, by changing a valid bit corresponding to the cache line selected as the replacement target cache line to a value (for example, “0”) that indicates invalidity.

The controller 4 stores (loads) the L2 L2P table data read from the NAND memory 5 in (to) the cache line selected as the replacement target cache line. The controller 4 updates an LRU timestamp corresponding to the cache line to which the L2 L2P table data read from the NAND memory 5 has been loaded. Subsequently, the controller 4 validates this cache line by changing the valid bit corresponding to the cache line to a value (for example, “1”) that indicates validity.

The controller 4 extracts, from the L2 L2P table data read from the NAND memory 5, an address designated by subfield 200C of the logical address. The controller 4 accesses the NAND memory 5 using the address, thereby reading the desired data portion (L1 L2P table data) of the L1 L2P table 71 from the NAND memory 5.

The controller 4 refers to the cache tag 131B, thereby searching for an invalid cache line. If such an invalid cache line exists, the controller 4 may select the invalid cache line as a replacement target cache line.

In contrast, if no invalid cache line exists, the controller 4 may select a replacement target cache line from valid cache lines, using the LRU timestamps of the valid cache lines. At this time, a cache line storing a data portion of a table that has a small access range covered by one data portion (one cache line) is selected preferentially as the replacement target cache line. After that, the controller 4 invalidates the cache line selected as the replacement target cache line, by changing a valid bit corresponding to the cache line selected as the replacement target cache line to a value (for example, “0”) that indicates invalidity.

The controller 4 stores (loads) the L1 L2P table data read from the NAND memory 5 in (to) the cache line selected as the replacement target cache line. The controller 4 updates an LRU timestamp corresponding to the cache line to which the L1 L2P table data read from the NAND memory 5 has been loaded. Subsequently, the controller 4 validates this cache line by changing the valid bit corresponding to the cache line to a value (for example, “1”) that indicates validity.

The controller 4 extracts, from the L1 L2P table data read from the NAND memory 5, a physical address designated by subfield 200D of the logical address. The controller 4 accesses the NAND memory 5 using this physical address, thereby reading user data designated by the logical address in the read command from the NAND memory 5. The controller 4 transmits the read user data to the host 2.

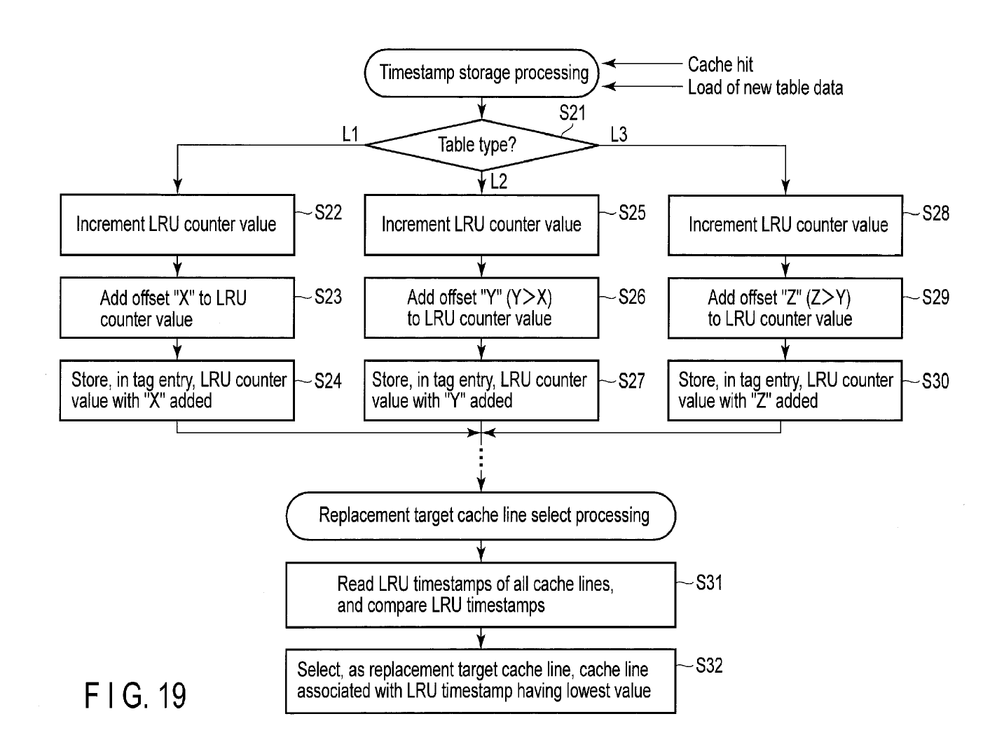

The flowchart of FIG. 19 shows a procedure example of timestamp update processing and replacement target cache-line selection processing.

Assume here that timestamp update processing including the second timestamp control processing described referring to FIG. 12 is performed.

The controller 4 may perform the following timestamp update processing when a cache hit has occurred (an event of a cache hit), or when new table data has been loaded (an event of a load of new table data).

A cache line in which a cache hit has occurred, or a cache line to which new table data has been loaded, is regarded as a cache line whose LRU timestamp should be updated.

The controller 4 determines, at the time of a cache hit, the type (table type) of table data already stored in the corresponding cache line, and determines, at the time of loading of new table data, the type (table type) of new table data loaded to the cache line (step S21).

If the table type indicates the L1 L2P table, the controller 4 increments the LRU counter value (step S22), and adds an offset of “X” to the incremented LRU counter value (step S23). After that, the controller 4 stores the resultant LRU counter value to which “X” is added, in a tag entry corresponding to the cache line as an LRU timestamp (step S24).

If the table type indicates the L2 L2P table, the controller 4 increments the LRU counter value (step S25), and adds an offset of “Y” to the incremented LRU counter value (step S26). After that, the controller 4 stores the resultant LRU counter value to which “Y” is added, in a tag entry corresponding to the cache line as an LRU timestamp (step S27).

If the table type indicates the L3 L2P table, the controller 4 increments the LRU counter value (step S28), and adds an offset of “Z” to the incremented LRU counter value (step S29). After that, the controller 4 stores the resultant LRU counter value to which “Z” is added, in a tag entry corresponding to the cache line as an LRU timestamp (step S30).

When it is necessary, because of a cache miss, to replace the content of a certain cache line with new table data (that is, when a cache miss has occurred and there is no invalid cache line), replacement target cache-line selection processing is executed. In this replacement target cache-line selection processing, if the L2P table cache 131 is a fully associative cache, the controller 4 reads LRU timestamps corresponding to all cache lines from respective tag entries, and compares the read LRU timestamps (step S31). The controller 4 selects, as a replacement target cache line, a cache line associated with the lowest LRU timestamp (step S32). After that, the controller 4 evicts the cache line selected as the replacement target cache line, and replaces the content of this cache line with new table data.

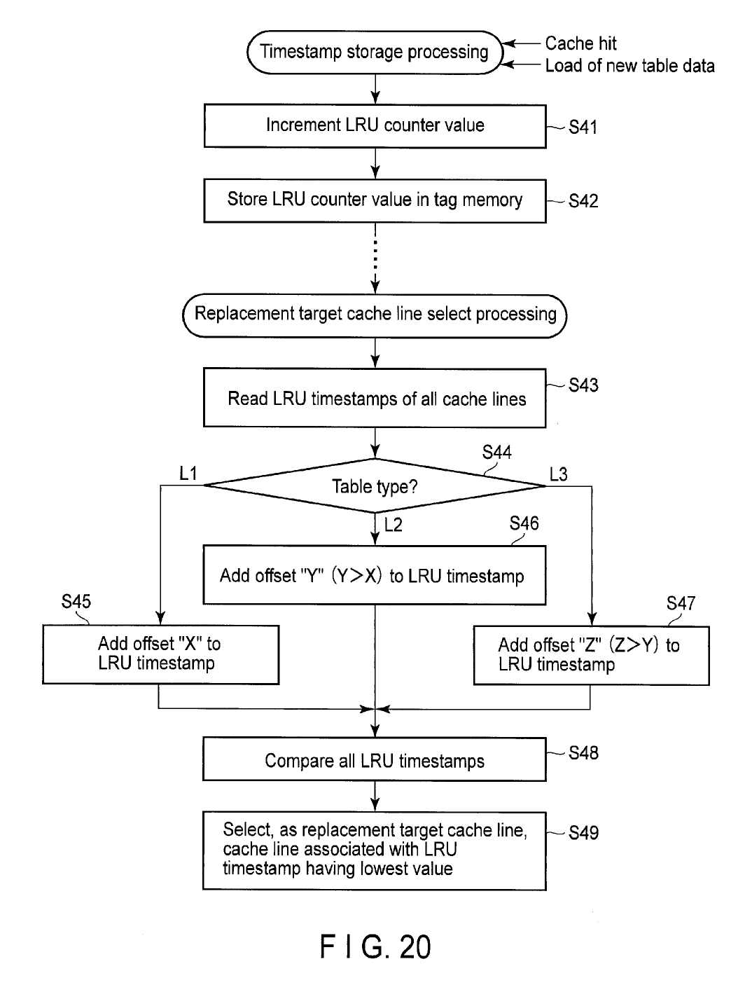

The flowchart of FIG. 20 shows another procedure example of timestamp update processing and replacement target cache-line selection processing.

Assume here that timestamp update processing including the third timestamp control processing described referring to FIG. 13 is performed.

The controller 4 may perform the following timestamp update processing when an event of a cache hit or an event of a load of new table data has occurred.

The controller 4 increments the LRU counter value (step S41), and stores the incremented LRU counter value as an LRU timestamp in tag entry corresponding to a cache line in which the cache hit or new table data loading has occurred (step S42).

In the replacement target cache-line selection processing, if the L2P table cache 131 is the fully associative cache, the controller 4 reads LRU timestamps corresponding to all cache lines from respective tag entries (step S43). The controller 4 determines respective table types corresponding to all cache lines (step S44).

If a table type in table data stored in a cache line associated with a read LRU timestamp indicates the L1 L2P table, the controller 4 adds an offset of “X” to the LRU timestamp (step S45).

If the table type in the table data stored in the cache line associated with the read LRU timestamp indicates the L2 L2P table, the controller 4 adds an offset of “Y” to the LRU timestamp (step S46).

If the table type in the table data stored in the cache line associated with the read LRU timestamp indicates the L3 L2P table, the controller 4 adds an offset of “Z” to the LRU timestamp (step S47).

The controller 4 compares the LRU timestamps, each of which “X,” “Y” or “Z” is added to (step S48), and selects, as the replacement target cache line, a cache line associated with the lowest LRU timestamp (step S49). After that, the controller 4 evicts the cache line selected as the replacement target cache line, and replaces the content of this cache line with new table data.

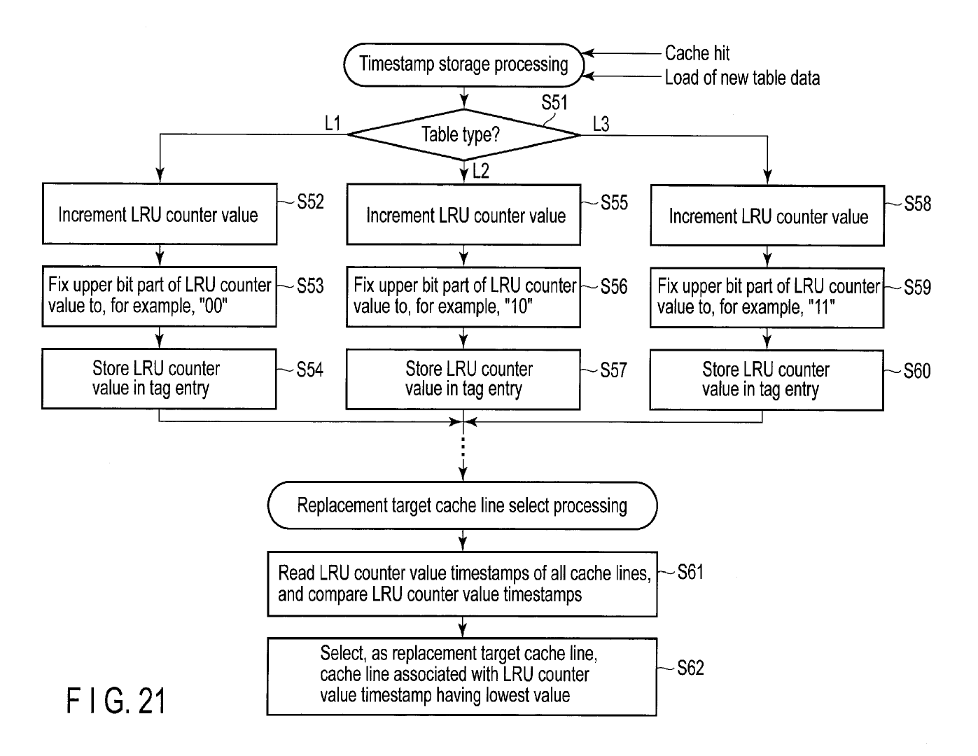

The flowchart of FIG. 21 shows yet another procedure example of timestamp update processing and replacement target cache-line selection processing.

Assume here that timestamp update processing including the first timestamp control processing described referring to FIG. 11 is performed.

The controller 4 determines, at the time of a cache hit, the type (table type) of table data already stored in the corresponding cache line, and determines, at the time of loading of new table data, the type (table type) of new table data located to the cache line (step S51).

If the table type indicates the L1 L2P table, the controller 4 increments the LRU counter value (step S52), and changes the upper two bits of the incremented LRU counter value to, for example, “00” to fix them at “00” (step S53). After that, the controller 4 stores the LRU counter value with its upper two bits fixed at “00” as an LRU timestamp in a tag entry corresponding to the cache line (step S54).

If the table type indicates the L2 L2P table, the controller 4 increments the LRU counter value (step S55), and changes the upper two bits of the incremented LRU counter value to, for example, “10” to fix them at “10” (step S56). After that, the controller 4 stores the LRU counter value with its upper two bits fixed at “10” as an LRU timestamp in a tag entry corresponding to the cache line (step S57).

If the table type indicates the L3 L2P table, the controller 4 increments the LRU counter value (step S58), and changes the upper two bits of the incremented LRU counter value to, for example, “11” to fix them at “11” (step S59). After that, the controller 4 stores the LRU counter value with its upper two bits fixed at “11” as an LRU timestamp in a tag entry corresponding to the cache line (step S60).

In the replacement target cache-line selection processing, if the L2P table cache 131 is the fully associative cache, the controller 4 reads LRU timestamps corresponding to all cache lines from respective tag entries, and compares the read LRU timestamps (step S61). The controller 4 selects, as a replacement target cache line, a cache line associated with the lowest LRU timestamp (step S62). After that, the controller 4 evicts the cache line selected as the replacement target cache line, and replaces the content of this cache line with new table data.

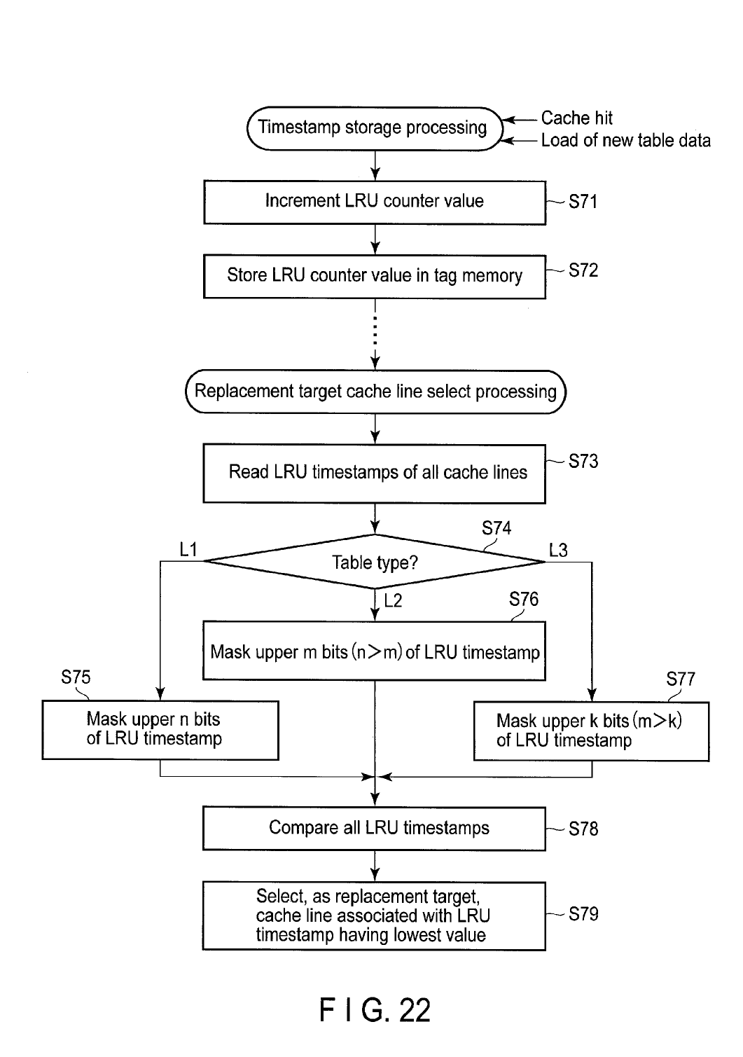

The flowchart of FIG. 22 shows a further procedure example of timestamp update processing and replacement target cache-line selection processing.

Assume here that timestamp update processing including the fourth timestamp control processing described referring to FIG. 14 is performed.

The controller 4 may perform the following timestamp update processing when an event of a cache hit or an event of a load of new table data has occurred.

The controller 4 increments the LRU counter value (step S71), and stores the incremented LRU counter value as an LRU timestamp in tag entry corresponding to a cache line in which the event of the cache hit or new table data loading has occurred (step S72).

In the replacement target cache-line selection processing, if the L2P table cache 131 is the fully associative cache, the controller 4 reads LRU timestamps corresponding to all cache lines from respective tag entries (step S73). The controller 4 determines respective table types corresponding to all cache lines (step S74).

If a table type in table data stored in a cache line associated with a read LRU timestamp indicates the L1 L2P table, the controller 4 masks the upper n bits of the LRU timestamp (step S75).

If the table type in table data stored in the cache line associated with the read LRU timestamp indicates the L2 L2P table, the controller 4 masks the upper m (n>m) bits of the LRU timestamp (step S76).

If the table type in table data stored in the cache line associated with the read LRU timestamp indicates the L3 L2P table, the controller 4 masks the upper k (m>k) bits of the LRU timestamp (step S77).

The controller 4 compares the masked LRU timestamps (step S78), and selects, as a replacement target cache line, a cache line associated with the lowest LRU timestamp (step S79). After that, the controller 4 evicts the cache line selected as the replacement target cache line, and replaces the content of this cache line with new table data.

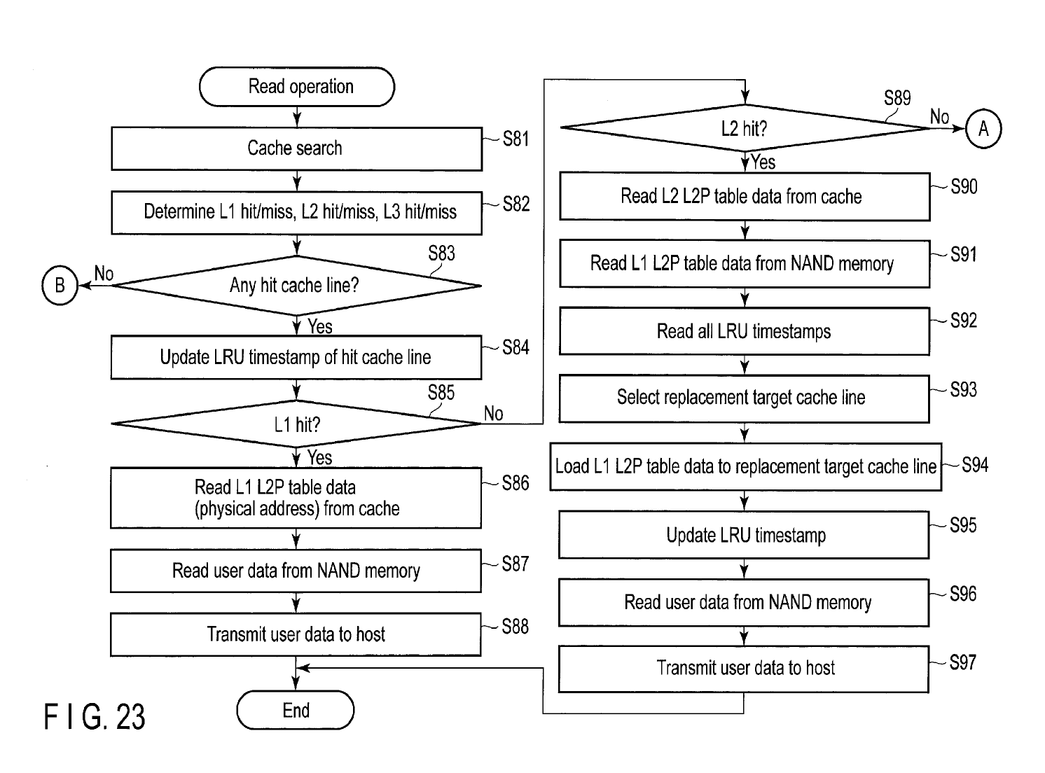

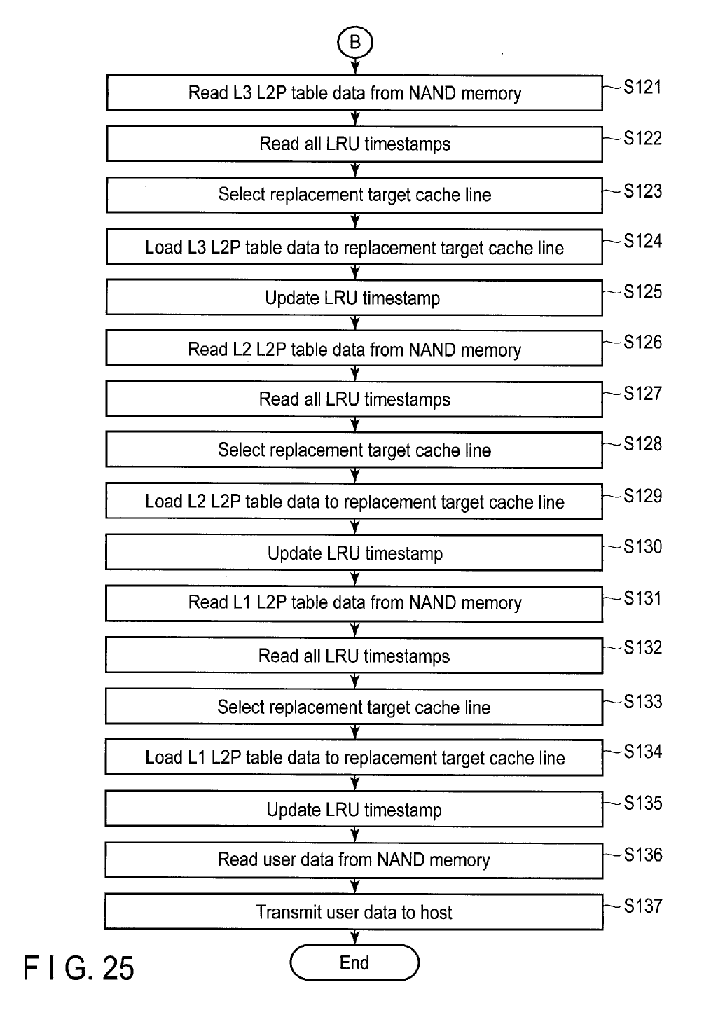

The flowcharts of FIGS. 23 to 25 show a procedure of a read operation performed by the controller 4.

It is assumed below that the L2P table cache 131 is the fully associative cache.

When having received a read command from the host 2, the controller 4 first searches the L2P table cache 131 for a data portion (table data) of the multilevel L2P table 7 necessary to translate, into a physical address, a logical address designated by the read command (step S81). If the L2P table cache 131 is the fully associative cache, the search of the L2P table cache 131 is realized by, for example, referring to all tag entries of the cache tag 131B. The controller 4 may all determine, by searching the L2P table cache 131, a cache hit/cache miss associated with the L1 L2P table 71, a cache hit/cache miss associated with the L2 L2P table 72, and a cache hit/cache miss associated with the L3 L2P table 73 (step S82).

In the cache-hit/cache-miss determination associated with the L1 L2P table 71, it is determined whether a cache line including a desired data portion of the L1 L2P table 71 (desired table data) corresponding to the logical address exists, by referring to a tag address and a type field in each tag entry. The desired table data of the L1 L2P table 71 indicates a location (physical address) in the NAND memory 5, where user data designated by the logical address is stored.

In the cache-hit/cache-miss determination associated with the L2 L2P table 72, it is determined whether a cache line including a desired data portion of the L2 L2P table 72 (desired table data) corresponding to the logical address exists, by referring to a tag address and a type field in each tag entry. The desired table data of the L2 L2P table 72 indicates a location in the NAND memory 5, where the above-mentioned desired table data of the L1 L2P table 71 is stored.

In the cache-hit/cache-miss determination associated with the L3 L2P table 73, it is determined whether a cache line including a desired data portion of the L3 L2P table 73 (desired table data) corresponding to the logical address exists, by referring to a tag address and a type field in each tag entry. The desired table data of the L3 L2P table 73 indicates a location in the NAND memory 5, where the above-mentioned desired table data of the L2 L2P table 72 is stored.

The controller 4 determines whether a cache line where a cache hit has occurred has been detected in the cache-hit/cache-miss determination associated with tables 71, 72 and 73 (step S83). If such a cache line has been detected (YES in step S83), the controller 4 may update an LRU timestamp corresponding to each of these cache line (step S84).

If the desired table data (physical address) of the L1 L2P table 71 corresponding to the logical address exists in the L2P table cache 131 (L1 hit) (YES in step S85), the controller may perform the following processing.

That is, the controller reads the desired table data of the L1 L2P table 71 from the L2P table cache 131 (step S86). The controller reads user data from a location in the NAND memory 5 designated by the desired table data (step S89). After that, the controller transmits the read user data to the host 2 (step S88).

If the desired table data of the L1 L2P table 71 corresponding to the logical address does not exist in the L2P table cache 131 (L1 miss) (NO in step S85), and if the desired table data of the L2 L2P table 72 corresponding to the logical address exists in the L2P table cache 131 (L2 hit) (YES in step S89), the controller may perform the following processing.

That is, the controller 4 reads the desired table data of the L2 L2P table 72 from the L2P table cache 131 (step S90). The controller reads the desired table data of the L1 L2P table 71 from a location in the NAND memory 5 designated by the desired table data of the L2 L2P led table 72 (step S91). The controller 4 reads all LRU timestamps from all tag entries (step S92). Using these LRU timestamps, the controller executes processing of preferentially selecting, as a replacement target cache line, a cache line that includes table data of a small cover access range (step S93). The controller 4 stores (loads) the read desired table data of the L1 L2P table 71 in (to) the selected replacement target cache line (step S94). The controller 4 stores a new LRU timestamp in a tag entry corresponding to this replacement target cache line, thereby updating the LRU timestamp corresponding to the selected replacement target cache line (step S95). The controller reads user data from a location in the NAND memory 5 designated by the read desired table data of the L1 L2P table 71 (step S96). After that, the controller transmits the read user data to the host 2 (step S97).

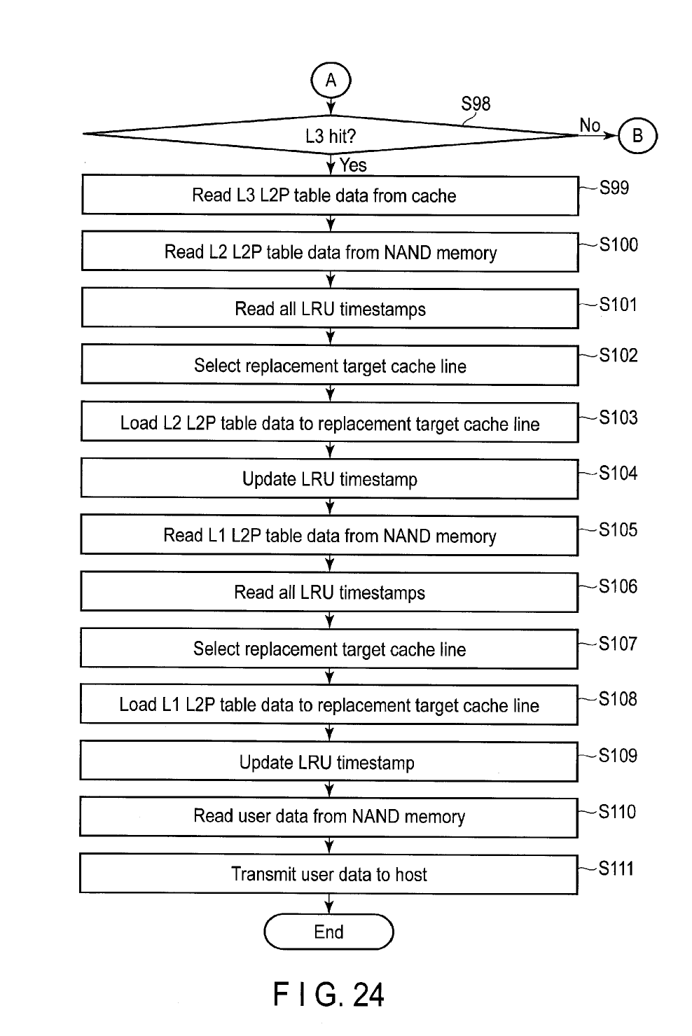

If the desired table data of the L1 L2P table 71 corresponding to the logical address does not exist in the L2P table cache 131 (L1 miss) (NO in step S85), if the desired table data of the L2 L2P table 72 corresponding to the logical address does not exist in the L2P table cache 131 (L2 miss) (NO in step S89), and if the desired table data of the L3 L2P table 73 corresponding to the logical address exists in the L2P table cache 131 (L3 hit) (YES in step S98 in FIG. 24), the controller may perform the following processing.

That is, the controller 4 reads the desired table data of the L3 L22 table 73 from the L2P table cache 131 (step S99). The controller reads the desired table data of the L2 L2P table 72 from a location in the NAND memory 5 designated by the desired table data of the L3 L2P led table 73 (step S100). The controller 4 reads all LRU timestamps from all tag entries (step S101). Using these LRU timestamps, the controller executes processing of preferentially selecting, as a replacement target cache line, a cache line that includes table data of a small cover access range (step S102). The controller 4 stores (loads) the read desired table data of the L2 L2P table 72 in (to) the selected replacement target cache line (step S103). The controller 4 stores a new LRU timestamp in a tag entry corresponding to the selected replacement target cache line, thereby updating the LRU timestamp corresponding to the selected replacement target cache line (step S104). The controller reads the desired table data of the L1 L2P table 71 from a location in the NAND memory 5 designated by the read desired table data of the L2 L2P table 72 (step S105). The controller 4 reads all LRU timestamps from all tag entries (step S106). Using these LRU timestamps, the controller executes processing of preferentially selecting, as a replacement target cache line, a cache line that includes table data of a small cover access range (step S107). The controller 4 stores (loads) the read desired table data of the L1 L2P table 71 in (to) the selected replacement target cache line (step S108). The controller 4 stores a new LRU timestamp in a tag entry corresponding to the selected replacement target cache line, thereby updating the LRU timestamp corresponding to the selected replacement target cache line (step S109). The controller reads user data from a location in the NAND memory 5 designated by the read desired table data of the L1 L2P table 71 (step S110). After that, the controller transmits the read user data to the host 2 (step S111).

If the desired table data of the L1 L2P table 71 corresponding to the logical address does not exist in the L2P table cache 131 (L1 miss) (NO in step S85), if the desired table data of the L2 L2P table 72 corresponding to the logical address does not exist in the L2P table cache 131 (L2 miss) (NO in step S89), and if the desired table data of the L3 L2P table 73 corresponding to the logical address does not exist in the L2P table cache 131 (L3 miss) (YES in step S98), the controller may perform the following processing.

That is, based on the logical address, the controller 4 obtains the address of the desired table data of the L3 L2P table 73 from the root table 74, and reads, using this address, the desired table data of the L3 L2P table 73 from the NAND memory 5 (step S121). The controller 4 reads all LRU timestamps from all tag entries (step S122). Using these LRU timestamps, the controller executes processing of preferentially selecting, as a replacement target cache line, a cache line that includes table data of a small cover access range (step S123). The controller 4 stores (loads) the read desired table data of the L3 L2P table 73 in (to) the selected replacement target cache line (step S124). The controller 4 stores a new LRU timestamp in a tag entry corresponding to the selected replacement target cache line, thereby updating the LRU timestamp corresponding to the selected replacement target cache line (step S125).

The controller 4 reads the desired table data of the L2 L2P table 72 from a location in the NAND memory 5 designated by the read desired table data of the L3 L2P table 73 (step S126). The controller 4 reads all LRU timestamps from all tag entries (step S127). Using these LRU timestamps, the controller executes processing of preferentially selecting, as a replacement target cache line, a cache line that includes table data of a small cover access range (step S128). The controller 4 stores (loads) the read desired table data of the L2 L2P table 72 in (to) the selected replacement target cache line (step S129). The controller 4 stores a new LRU timestamp in a tag entry corresponding to the selected replacement target cache line, thereby updating the LRU timestamp corresponding to the selected replacement target cache line (step S130).

The controller reads the desired table data of the L1 L2P table 71 from a location in the NAND memory 5 designated by the read desired table data of the L2 L2P table 72 (step S131). The controller 4 reads all LRU timestamps from all tag entries (step S132). Using these LRU timestamps, the controller executes processing of preferentially selecting, as a replacement target cache line, a cache line that includes table data of a small cover access range (step S133). The controller 4 stores (loads) the read desired table data of the L1 L2P table 71 in (to) the selected replacement target cache line (step S134). The controller 4 stores a new LRU timestamp in a tag entry corresponding to the selected replacement target cache line, thereby updating the LRU timestamp corresponding to the selected replacement target cache line (step S135). The controller reads user data from a location in the NAND memory 5 designated by the read desired table data of the L1 L2P table 71 (step S136). After that, the controller transmits the read user data to the host 2 (step S137).

A description has mainly been given of a procedure of a read operation performed when the multilevel L2P table 7 has a configuration as shown in FIG. 5. However, if the multilevel L2P table 7 has a configuration as shown in FIG. 6, in the search of the L2P table cache 131, the controller 4 may first determine, based on a logical address, a cache hit or a cache miss associated with the type-1 L1 L2P table 71′, and a cache hit or a cache miss associated with the type-1 L2 L2P table 72′. After that, the controller 4 may read the table data of the type-1 L1 L2P table 71′ corresponding to the logical address from the L2P table cache 131 or the NAND memory 5, and may then determine, based on a type-2 address designated by the table data of the type-1 L1 L2P table 71′, a cache hit or a cache miss associated with the type-2 L1 L2P table 81.

As described above, according to the embodiment, plural types of tables included in the multilevel L2P table 7 are cached in the L2P table cache 131. Further, a cache line containing a data portion of a table type having a small access range (capacity) covered by a data portion corresponding to one cache line is preferentially evicted from the L2P table cache 131. This enables a data portion of a table type having a large access range (capacity) covered by a data portion corresponding to one cache line, namely, a data portion of a table type having a high hit ratio, to be preferentially retained in the L2P table cache 131. As a result, the number of read accesses to the multilevel L22 table 7, which is necessary for logical-to-physical address translation, can be reduced. Accordingly, logical-to-physical address translation can be performed efficiently.

Moreover, by applying the second LRU timestamp control processing shown in FIG. 12, or the third LRU timestamp control processing shown in FIG. 13, the ratio among data portions of different table types retained in one L2P table cache 131 can be adaptively controlled in accordance with the size of a range accessed by the host 2. This enables logical-to-physical address translation, which utilizes the multilevel L2P table 7 including a plurality of hierarchical tables, to be executed efficiently with a small number of resources, for example, using only one L2P table cache 131.

In addition, the embodiment employs a NAND memory as an example of the nonvolatile memory. However, the function of the embodiment is also applicable to other various nonvolatile memories, such as a three-dimensional flash memory, a magnetoresistive random access memory (MRAM), a phase-change random access memory (PRAM), a resistive random access memory (ReRAM), and a ferroelectric random access memory (FeRAM).

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A memory system comprising:
a nonvolatile memory storing a multilevel address translation table used for translating a logical address into a physical address in the nonvolatile memory, the multilevel address translation table comprising at least hierarchical first and second tables, the first table including a plurality of data portions, the second table including a plurality of data portions, access ranges covered by the respective data portions of the second table being wider than access ranges covered by the respective data portions of the first table;
a controller electrically connected to the nonvolatile memory, and configured to:
translate the logical address into a physical address by accessing a cache configured to cache both the first and second tables, the cache including a plurality of cache lines, each of the cache lines storing one of the data portions included in the first table or one of the data portions included in the second table; and
evict, from the cache, one of the cache lines which store the data portions of the first table in preference to the cache lines which store the data portions of the second table, when replacement of one of the cache lines is to be performed because of a cache miss in the cache.

2. The memory system of claim 1, wherein
the controller stores a plurality of least recently used (LRU) timestamps corresponding to the respective cache lines, and updates each of the LRU timestamps for each access of a data portion included in a corresponding cache line; and
the controller is further configured to:
update an LRU timestamp corresponding to a first cache line, which stores the data portion of the first table, to a value obtained by adding a first value to a counter value;
update an LRU timestamp corresponding to a second cache line, which stores the data portion of the second table, to a value obtained by adding a second value larger than the first value to the counter value; and
evict, from the cache, a cache line included in replacement target cache-line candidates and associated with an LRU timestamp having a lowest value.

3. The memory system of claim 1, wherein
the controller stores a plurality of least recently used (LRU) timestamps corresponding to the respective cache lines, and updates each of the LRU timestamps for each access of a data portion included in a corresponding cache line; and
the controller is further configured to:
select, from the cache, a plurality of cache line candidates which serve as replacement targets, and read, from the cache, LRU timestamps corresponding to the cache line candidates, when replacement of one of the cache lines is to be performed because of a cache miss in the cache;
add a first value to each of the read LRU timestamps when the read LRU timestamps correspond to the cache lines which store the data portions of the first table;
add a second value greater than the first value to each of the read LRU timestamps when the read LRU timestamps correspond to the cache lines which store the data portions of the second table; and
evict, from the cache, a cache line associated with an LRU timestamp having a lowest value, which is included in the LRU timestamps to each of which the first value or the second value is added.

4. The memory system of claim 1, wherein
the controller stores a plurality of least recently used (LRU) timestamps corresponding to the respective cache lines, and updates each of the LRU timestamps for each access of a data portion included in a corresponding cache line; and
the controller is further configured to:
select, from the cache, a plurality of cache line candidates which serve as replacement targets;
update an LRU timestamp corresponding to a first cache line, which is included in the cache line candidates and stores the data portion of the first table, to a value obtained by fixing, to a first value, only an upper bit part of a plurality of bits which represent a counter value;
update an LRU timestamp corresponding to a second cache line, which is included in the cache line candidates and stores the data portion of the second table, to a value obtained by fixing, to a second value greater than the first value, only the upper bit part of the bits which represent the counter value; and
evict, from the cache, a cache line included in the cache line candidates and associated with an LRU timestamp having a lowest value, which is included in the updated LRU timestamps.

5. The memory system of claim 1, wherein
the controller stores a plurality of least recently used (LRU) timestamps corresponding to the respective cache lines, and updates each of the LRU timestamps for each access of a data portion included in a corresponding cache line; and
the controller is further configured to:
select, from the cache, a plurality of cache line candidates which serve as replacement targets, and read LRU timestamps corresponding to the cache line candidates, when replacement of one of the cache lines is to be performed;
mask a plurality of bits representing each of the read URL timestamps, using a first mask pattern for masking an upper bit part having a first bit width, or a second mask pattern for masking an upper bit part having a second bit width narrower than the first bit width, the first mask pattern being used to mask an LRU timestamp corresponding to each of first cache lines which store the data portions of the first table, the second mask pattern being used to mask an LRU timestamp corresponding to each of second cache lines which store the data portions of the second table; and
evict, from the cache, a cache line associated with an LRU timestamp having a lowest value, which is included in the masked read LRU timestamps.

6. The memory system of claim 1, wherein
the multilevel address translation table further includes a third table;
the cache is configured to cache the first table, the second table and the third table;
an access range covered by each of a plurality of data portions of the third table is wider than the access range covered by each of the plurality of data portions of the second table; and
the controller is further configured to
evict, from the cache, a cache line storing the data portion of the first table in preference to a cache line storing the data portion of the third table and a cache line storing the data portion of the second table, and evict, from the cache, a cache line storing the data portion of the second table in preference to a cache line storing the data portion of the third table.

7. The memory system of claim 1, wherein
each of the data portions of the first table includes a plurality of physical addresses, each of the physical addresses indicating a location in the nonvolatile memory, where user data is stored; and
each of the data portions of the second table includes a plurality of entries, each of the entries indicating a location in the nonvolatile memory, where a corresponding one of the data portions of the first table is stored.

8. The memory system of claim 7, wherein locations in the nonvolatile memory, where the data portions of the second table are stored, are managed by system management information loaded from the nonvolatile memory to a random access memory in the controller.

9. The memory system of claim 8, wherein the controller loads the system management information from the nonvolatile memory to the random access memory when the memory system is started.

10. The memory system of claim 9, wherein
the logical address includes a first field, a second field and a third field; and
the controller is further configured to:
obtain an address of the system management information by using the first field, and read data of the system management information corresponding to the obtained address;
specify, by using the read data, one data portion from the data portions of the second table;
read, by using the second field, one entry of the entries included in the determined data portion of the second table;
specify, by using the read entry, one data portion from the data portions of the first table; and
specify, by using the third field, one physical address in the physical addresses included in the determined data portion of the first table, and determine that the determined physical address is a physical address corresponding to the logical address.

11. The memory system of claim 1, wherein the cache is implemented in a random access memory included in the controller.

12. The memory system of claim 1, wherein the cache is a fully associative cache.

13. A method for controlling a memory system including a nonvolatile memory, the method comprising:
managing a multilevel address translation table used for translating a logical address into a physical address in the nonvolatile memory, the multilevel address translation table comprising at least hierarchical first and second tables, the first table including a plurality of data portions, the second table including a plurality of data portions, access ranges covered by the respective data portions of the second table being wider than access ranges covered by the respective data portions of the first table;
translating the logical address into a physical address by accessing a cache configured to cache both the first and second tables, the cache including a plurality of cache lines, each of the cache lines storing one of the data portions included in the first table or one of the data portions included in the second table; and
evicting, from the cache, one of the cache lines which store the data portions of the first table in preference to the cache lines which store the data portions of the second table, when replacement of one of the cache lines is to be performed because of a cache miss in the cache.

14. The method of claim 13, further comprising:
storing a plurality of least recently used (LRU) timestamps corresponding to the respective cache lines;
updating each of the LRU timestamps for each access of a data portion included in a corresponding cache line;
generating a counter value;
updating an LRU timestamp, which corresponds to a first cache line storing a data portion of the first table, to a value obtained by adding a first value to the generated counter value; and
updating an LRU timestamp, which corresponds to a second cache line storing a data portion of the second table, to a value obtained by adding a second value greater than the first value to the generated counter value,
wherein the evicting includes evicting, from the cache, a cache line associated with an LRU timestamp having a lowest value.

15. The method of claim 13, further comprising:
storing a plurality of least recently used (LRU) timestamps corresponding to the respective cache lines;
updating each of the LRU timestamps for each access of a data portion included in a corresponding cache line; and
the evicting includes:
selecting, from the cache, a plurality of cache line candidates which serve as replacement targets, and reading, from the cache, LRU timestamps corresponding to the cache line candidates, when replacement of one of the cache lines is to be performed because of a cache miss in the cache;
adding a first value to each of the read LRU timestamps when the read LRU timestamps correspond to the cache lines which store the data portions of the first table;
adding a second value greater than the first value to each of the read LRU timestamps when the read LRU timestamps correspond to the cache lines which store the data portions of the second table; and
evicting, from the cache, a cache line associated with an LRU timestamp having a lowest value, which is included in the LRU timestamps to each of which the first value or the second value is added.

16. The method of claim 13, further comprising:
storing a plurality of least recently used (LRU) timestamps corresponding to the respective cache lines;
updating each of the LRU timestamps for each access of a data portion included in a corresponding cache line;
generating a counter value;
selecting, from the cache, a plurality of cache line candidates which serve as replacement targets;
updating an LRU timestamp corresponding to a first cache line, which is included in the cache line candidates and stores the data portion of the first table, to a value obtained by fixing, to a first value, an upper bit part of a plurality of bits which represent the generated counter value; and
updating an LRU timestamp corresponding to a second cache line, which is included in the cache line candidates and stores the data portion of the second table, to a value obtained by fixing, to a second value greater than the first value, the upper bit part of the bits which represent the generated counter value,
wherein the evicting includes evicting, from the cache, a cache line included in the cache line candidates and associated with an LRU timestamp having a lowest value, which is included in the updated LRU timestamps.

17. The method of claim 13, further comprising:
storing a plurality of least recently used (LRU) timestamps corresponding to the respective cache lines; and
updating each of the LRU timestamps for each access of a data portion included in a corresponding cache line,
the evicting includes:
selecting, from the cache, a plurality of cache line candidates which serve as replacement targets, and reading LRU timestamps corresponding to the cache line candidates, when replacement of one of the cache lines is to be performed;
masking a plurality of bits representing each of the read URL timestamps, using a first mask pattern for masking an upper bit part having a first bit width, or a second mask pattern for masking an upper bit part having a second bit width narrower than the first bit width, the first mask pattern being used to mask an LRU timestamp corresponding to each of first cache lines which store the data portions of the first table, the second mask pattern being used to mask an LRU timestamp corresponding to each of second cache lines which store the data portions of the second table; and
evicting, from the cache, a cache line associated with an LRU timestamp having a lowest value, which is included in the masked read LRU timestamps.

18. The method of claim 13, wherein
the multilevel address translation table further includes a third table;
the first table, the second table and the third table are cached;
an access range covered by each of a plurality of data portions of the third table is wider than the access range covered by each of the plurality of data portions of the second table; and
the evicting includes evicting, from the cache, a cache line storing the data portion of the first table in preference to a cache line storing the data portion of the third table and a cache line storing the data portion of the second table, and evicting, from the cache, a cache line storing the data portion of the second table in preference to a cache line storing the data portion of the third table.

19. The method of claim 13, wherein
each of the data portions of the first table includes a plurality of physical addresses, each of the physical addresses indicating a location in the nonvolatile memory, where user data is stored; and
each of the data portions of the second table includes a plurality of entries, each of the entries indicating a location in the nonvolatile memory, where a corresponding one of the data portions of the first table is stored.

20. The method of claim 19, further comprising:
loading system management information from the nonvolatile memory to a random access memory in the memory system; and
managing, using the system management information, locations in the nonvolatile memory, where the data portions of the second table are stored.
